(19) United States
(12) Patent Application Publication
(10) Pub. No.: US 2020/0356050 A1
(43) Pub. Date: Nov. 12, 2020

(54) SPATIAL DEPOSITION OF RESINS WITH DIFFERENT FUNCTIONALITY

(71) Applicant: Facebook Technologies, LLC, Menlo Park, CA (US)

(72) Inventors: Austin Lane, Sammamish, WA (US); Matthew E. Colburn, Woodinville, WA (US)

(21) Appl. No.: 16/865,105

(22) Filed: May 1, 2020

Related U.S. Application Data
(60) Provisional application No. 62/845,154, filed on May 8, 2019.

(51) Int. Cl. G03H 1/02

(52) U.S. Cl. CPC G03H 1/0252; G03H 2260/12; G03H 2250/12; G03H 2223/23

(57) ABSTRACT

Techniques disclosed herein relate to optical devices. Resins with different optical properties can be deposited in different areas to provide increased optical functionality. It can be difficult to design a single photopolymer material that meets several technical requirements. Different resins can be deposited on the same substrate to make a single film with spatially varying properties. Different resins can also be applied to different substrates in a stack. By using different resins, an optical component can be made that meets several technical requirements.

### CROSS REFERENCE TO RELATED APPLICATIONS

This application claims priority to U.S. Provisional Application No. 62/845,154, filed on May 8, 2019, the disclosure of which is incorporated by reference in its entirety for all purposes.

The following two U.S. patent applications (including this one) are being filed concurrently, and the entire disclosure of the other application is incorporated by reference into this application for all purposes:
Application 16/______, filed May 1, 2020, entitled “Spatial Deposition of Resins with Different Functionality”; and
Application 16/______, filed May 1, 2020, entitled “Spatial Deposition of Resins with Different Functionality on Different Substrates.”

### BACKGROUND

An artificial reality system, such as a head-mounted display (HMD) or heads-up display (HUD) system, generally includes a near-eye display system in the form of a headset or a pair of glasses and configured to present content to a user via an electronic or optic display within, for example, about 10-20 mm in front of the user's eyes. The near-eye display system may display virtual objects or combine images of real objects with virtual objects, as in virtual reality (VR), augmented reality (AR), or mixed reality (MR) applications. For example, in an AR system, a user may view both images of virtual objects (e.g., computer-generated images (CGIs)) and the surrounding environment by, for example, seeing through transparent display glasses or lenses (often referred to as optical see-through).

One example of an optical see-through AR system may use a waveguide based optical display, where light of projected images may be coupled into a waveguide (e.g., a transparent substrate), propagate within the waveguide, and be coupled out of the waveguide at different locations. In some implementations, the light of the projected images may be coupled into or out of the waveguide using a diffractive optical element, such as a holographic grating. In some implementations, the artificial reality systems may employ eye-tracking subsystems that can track the user's eye (e.g., gaze direction) to modify or generate content based on the direction in which the user is looking, thereby providing a more immersive experience for the user. The eye-tracking subsystems may be implemented using various optical components, such as holographic optical elements.

### BRIEF DESCRIPTION OF THE DRAWINGS

Illustrative embodiments are described in detail below with reference to the following figures.

FIG. 1 is a simplified block diagram of an example of an artificial reality system environment including a near-eye display system according to certain embodiments.

FIG. 2 is a perspective view of an example of a near-eye display system in the form of a head-mounted display (HMD) device for implementing some of the examples disclosed herein.

FIG. 3 is a perspective view of an example of a near-eye display system in the form of a pair of glasses for implementing some of the examples disclosed herein.

FIG. 4 illustrates an example of an optical see-through augmented reality system using a waveguide display that includes an optical combiner according to certain embodiments.

FIG. 5A illustrates an example of a volume Bragg grating. FIG. 5B illustrates the Bragg condition for the volume Bragg grating shown in FIG. 5A.

FIG. 6A illustrates the recording light beams for recording a volume Bragg grating according to certain embodiments. FIG. 6B is an example of a holography momentum diagram illustrating the wave vectors of recording beams and reconstruction beams and the grating vector of the recorded volume Bragg grating according to certain embodiments.

FIG. 7 illustrates an example of a holographic recording system for recording holographic optical elements according to certain embodiments.

FIG. 8 is a simplified diagram of an embodiment of an inkjet depositing a first resin on a substrate.

FIG. 9 is a simplified diagram of an embodiment of the inkjet depositing a second resin on the substrate.

FIG. 10 illustrates a two-dimensional map of spatial frequency response of an embodiment of an optical device.

FIG. 11 is a simplified diagram of an embodiment of a stack having resins with different properties.

FIG. 12 is a chart of optical absorption of embodiments of different resins of a stack.

FIG. 13 is a simplified flow chart illustrating an example of a method of applying two materials to one substrate according to certain embodiments.

FIG. 14 is a simplified flow chart illustrating an example of a method of creating a stacked optical device according to certain embodiments.

FIG. 15 is a simplified block diagram of an example of an electronic system 1500 of a near-eye display system (e.g., HMD device) for implementing some of the examples disclosed herein according to certain embodiments.

The figures depict embodiments of the present disclosure for purposes of illustration only. One skilled in the art will readily recognize from the following description that alternative embodiments of the structures and methods illustrated may be employed without departing from the principles, or benefits touted, of this disclosure.

In the appended figures, similar components and/or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

Techniques disclosed herein relate generally to optical devices. More specifically, and without limitation, this disclosure relates to optical devices for artificial-reality systems. According to certain embodiments, a grating for an artificial-reality display is described. Various inventive embodiments are described herein, including systems, modules, devices, components, methods, and the like.

In an artificial reality system, such as an augmented reality (AR) or mixed reality (MR) system, to improve the performance of the system, such as improving the brightness of the displayed images, expanding the eyebox, reducing artifacts, increasing the field of view, and improving user interaction with presented content, various holographic optical elements may be used for light beam coupling and/or shaping. A volume Bragg grating can be used in an artificial-reality display (e.g., to couple light out of and/or into a waveguide). It can be difficult to design a single photopolymer material that meets many technical requirements (e.g., high dynamic range, low absorption & haze, good resolution at high & low spatial frequencies, sensitivity across visible spectrum, etc.). It can be especially difficult to design a single resin that is capable of patterning large pitch & small pitch features, due to reaction/diffusion mechanisms inherent to materials used. Accordingly, it can be beneficial to design several photopolymer materials that each meet only some requirements, but when combined into a single film or stack of films, meet all desired requirements. For some embodiments, this specification describes: (A) depositing different resins on the same substrate to make a single film with spatially varying properties (e.g., absorption, spatial frequency response, etc.); and (B) depositing different resins on different substrates and combining the different substrates either before or after exposure to make a single optical device.

As used herein, visible light may refer to light with a wavelength between about 380 nm and about 750 nm, between about 400 nm and about 700 nm, or between about 440 nm and about 650 nm. Near infrared (NIR) light may refer to light with a wavelength between about 750 nm to about 2500 nm. The desired infrared (IR) wavelength range may refer to the wavelength range of IR light that can be detected by a suitable IR sensor (e.g., a complementary metal-oxide semiconductor (CMOS), a charge-coupled device (CCD) sensor, or an InGaAs sensor), such as between 830 nm and 860 nm, between 930 nm and 980 nm, or between about 750 nm to about 1000 nm.

As also used herein, a substrate may refer to a medium within which light may propagate. The substrate may include one or more types of dielectric materials, such as glass, quartz, plastic, polymer, poly (methyl methacrylate) (PMMA), crystal, or ceramic. At least one type of material of the substrate may be transparent to visible light and NIR light. A thickness of the substrate may range from, for example, less than about 1 mm to about 10 mm or more. As used herein, a material may be “transparent” to a light beam if the light beam can pass through the material with a high transmission rate, such as larger than 60%, 75%, 80%, 90%, 95%, 98%, 99%, or higher, where a small portion of the light beam (e.g., less than 40%, 25%, 20%, 10%, 5%, 2%, 1%, or less) may be scattered, reflected, or absorbed by the material. The transmission rate (i.e., transmissivity) may be represented by either a weighted or an unweighted average transmission rate over a range of wavelengths, or the lowest transmission rate over a range of wavelengths, such as the visible wavelength range.

In the following description, for the purposes of explanation, specific details are set forth in order to provide a thorough understanding of examples of the disclosure. However, it will be apparent that various examples may be practiced without these specific details. For example, devices, systems, structures, assemblies, methods, and other components may be shown as components in block diagram form in order not to obscure the examples in unnecessary detail. In other instances, well-known devices, processes, systems, structures, and techniques may be shown without necessary detail in order to avoid obscuring the examples. The figures and description are not intended to be restrictive. The terms and expressions that have been employed in this disclosure are used as terms of description and not of limitation, and there is no intention in the use of such terms and expressions of excluding any equivalents of the features shown and described or portions thereof. The word “example” is used herein to mean “serving as an example, instance, or illustration.” Any embodiment or design described herein as “example” is not necessarily to be construed as preferred or advantageous over other embodiments or designs.

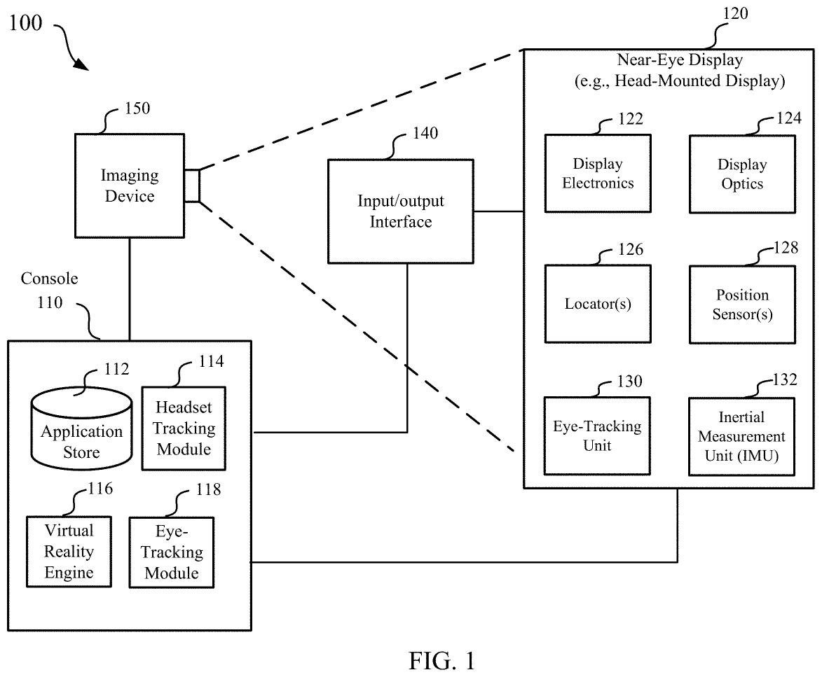

FIG. 1 is a simplified block diagram of an example of an artificial reality system environment 100 including a near-eye display system 120 in accordance with certain embodiments. Artificial reality system environment 100 shown in FIG. 1 may include near-eye display system 120, an optional imaging device 150, and an optional input/output interface 140 that may each be coupled to an optional console 110. While FIG. 1 shows example artificial reality system environment 100 including one near-eye display system 120, one imaging device 150, and one input/output interface 140, any number of these components may be included in artificial reality system environment 100, or any of the components may be omitted. For example, there may be multiple near-eye display systems 120 monitored by one or more external imaging devices 150 in communication with console 110. In some configurations, artificial reality system environment 100 may not include imaging device 150, optional input/output interface 140, and optional console 110. In alternative configurations, different or additional components may be included in artificial reality system environment 100. In some configurations, near-eye display systems 120 may include imaging device 150, which may be used to track one or more input/output devices (e.g., input/output interface 140), such as a handhold controller.

Near-eye display system 120 may be a head-mounted display that presents content to a user. Examples of content presented by near-eye display system 120 include one or more of images, videos, audios, or some combination thereof. In some embodiments, audios may be presented via an external device (e.g., speakers and/or headphones) that receives audio information from near-eye display system 120, console 110, or both, and presents audio data based on the audio information. Near-eye display system 120 may include one or more rigid bodies, which may be rigidly or non-rigidly coupled to each other. A rigid coupling between rigid bodies may cause the coupled rigid bodies to act as a single rigid entity. A non-rigid coupling between rigid bodies may allow the rigid bodies to move relative to each other. In various embodiments, near-eye display system 120 may be implemented in any suitable form factor, including a pair of glasses. Some embodiments of near-eye display system 120 are further described below. Additionally, in various embodiments, the functionality described herein may be used in a headset that combines images of an environment external to near-eye display system 120 and artificial reality content (e.g., computer-generated images). Therefore, near-eye display system 120 may augment images of a physical, real-world environment external to near-eye display system 120 with generated content (e.g., images, video, sound, etc.) to present an augmented reality to a user.

In various embodiments, near-eye display system 120 may include one or more of display electronics 122, display optics 124, and an eye-tracking system 130. In some embodiments, near-eye display system 120 may also include one or more locators 126, one or more position sensors 128, and an inertial measurement unit (IMU) 132. Near-eye display system 120 may omit any of these elements or include additional elements in various embodiments. Additionally, in some embodiments, near-eye display system 120 may include elements combining the function of various elements described in conjunction with FIG. 1.

Display electronics 122 may display or facilitate the display of images to the user according to data received from, for example, console 110. In various embodiments, display electronics 122 may include one or more display panels, such as a liquid crystal display (LCD), an organic light emitting diode (OLED) display, an inorganic light emitting diode (ILED) display, a micro light emitting diode (μLED) display, an active-matrix OLED display (AMOLED), a transparent OLED display (TOLED), or some other display. For example, in one implementation of near-eye display system 120, display electronics 122 may include a front TOLED panel, a rear display panel, and an optical component (e.g., an attenuator, polarizer, or diffractive or spectral film) between the front and rear display panels. Display electronics 122 may include pixels to emit light of a predominant color such as red, green, blue, white, or yellow. In some implementations, display electronics 122 may display a three-dimensional (3D) image through stereo effects produced by two-dimensional panels to create a subjective perception of image depth. For example, display electronics 122 may include a left display and a right display positioned in front of a user's left eye and right eye, respectively. The left and right displays may present copies of an image shifted horizontally relative to each other to create a stereoscopic effect (i.e., a perception of image depth by a user viewing the image).

In certain embodiments, display optics 124 may display image content optically (e.g., using optical waveguides and couplers), magnify image light received from display electronics 122, correct optical errors associated with the image light, and present the corrected image light to a user of near-eye display system 120. In various embodiments, display optics 124 may include one or more optical elements, such as, for example, a substrate, optical waveguides, an aperture, a Fresnel lens, a convex lens, a concave lens, a filter, input/output couplers, or any other suitable optical elements that may affect image light emitted from display electronics 122. Display optics 124 may include a combination of different optical elements as well as mechanical couplings to maintain relative spacing and orientation of the optical elements in the combination. One or more optical elements in display optics 124 may have an optical coating, such as an anti-reflective coating, a reflective coating, a filtering coating, or a combination of different optical coatings.

Magnification of the image light by display optics 124 may allow display electronics 122 to be physically smaller, weigh less, and consume less power than larger displays. Additionally, magnification may increase a field of view of the displayed content. The amount of magnification of image light by display optics 124 may be changed by adjusting, adding, or removing optical elements from display optics 124. In some embodiments, display optics 124 may project displayed images to one or more image planes that may be further away from the user's eyes than near-eye display system 120.

Display optics 124 may also be designed to correct one or more types of optical errors, such as two-dimensional optical errors, three-dimensional optical errors, or a combination thereof. Two-dimensional errors may include optical aberrations that occur in two dimensions. Example types of two-dimensional errors may include barrel distortion, pincushion distortion, longitudinal chromatic aberration, and transverse chromatic aberration. Three-dimensional errors may include optical errors that occur in three dimensions. Example types of three-dimensional errors may include spherical aberration, comatic aberration, field curvature, and astigmatism.

Locators 126 may be objects located in specific positions on near-eye display system 120 relative to one another and relative to a reference point on near-eye display system 120. In some implementations, console 110 may identify locators 126 in images captured by imaging device 150 to determine the artificial reality headset's position, orientation, or both. A locator 126 may be a light emitting diode (LED), a corner cube reflector, a reflective marker, a type of light source that contrasts with an environment in which near-eye display system 120 operates, or some combinations thereof. In embodiments where locators 126 are active components (e.g., LEDs or other types of light emitting devices), locators 126 may emit light in the visible band (e.g., about 380 nm to 750 nm), in the infrared (IR) band (e.g., about 750 nm to 1 mm), in the ultraviolet band (e.g., about 10 nm to about 380 nm), in another portion of the electromagnetic spectrum, or in any combination of portions of the electromagnetic spectrum.

Imaging device 150 may be part of near-eye display system 120 or may be external to near-eye display system 120. Imaging device 150 may generate slow calibration data based on calibration parameters received from console 110. Slow calibration data may include one or more images showing observed positions of locators 126 that are detectable by imaging device 150. Imaging device 150 may include one or more cameras, one or more video cameras, any other device capable of capturing images including one or more of locators 126, or some combinations thereof. Additionally, imaging device 150 may include one or more filters (e.g., to increase signal to noise ratio). Imaging device 150 may be configured to detect light emitted or reflected from locators 126 in a field of view of imaging device 150. In embodiments where locators 126 include passive elements (e.g., retroreflectors), imaging device 150 may include a light source that illuminates some or all of locators 126, which may retro-reflect the light to the light source in imaging device 150. Slow calibration data may be communicated from imaging device 150 to console 110, and imaging device 150 may receive one or more calibration parameters from console 110 to adjust one or more imaging parameters (e.g., focal length, focus, frame rate, sensor temperature, shutter speed, aperture, etc.).

Position sensors 128 may generate one or more measurement signals in response to motion of near-eye display system 120. Examples of position sensors 128 may include accelerometers, gyroscopes, magnetometers, other motion-detecting or error-correcting sensors, or some combinations thereof. For example, in some embodiments, position sensors 128 may include multiple accelerometers to measure translational motion (e.g., forward/back, up/down, or left/right) and multiple gyroscopes to measure rotational motion (e.g., pitch, yaw, or roll). In some embodiments, various position sensors may be oriented orthogonally to each other.

IMU 132 may be an electronic device that generates fast calibration data based on measurement signals received from one or more of position sensors 128. Position sensors 128 may be located external to IMU 132, internal to IMU 132, or some combination thereof. Based on the one or more measurement signals from one or more position sensors 128, IMU 132 may generate fast calibration data indicating an estimated position of near-eye display system 120 relative to an initial position of near-eye display system 120. For example, IMU 132 may integrate measurement signals received from accelerometers over time to estimate a velocity vector and integrate the velocity vector over time to determine an estimated position of a reference point on near-eye display system 120. Alternatively, IMU 132 may provide the sampled measurement signals to console 110, which may determine the fast calibration data. While the reference point may generally be defined as a point in space, in various embodiments, the reference point may also be defined as a point within near-eye display system 120 (e.g., a center of IMU 132).

Eye-tracking system 130 may include one or more eye-tracking systems. Eye tracking may refer to determining an eye's position, including orientation and location of the eye, relative to near-eye display system 120. An eye-tracking system may include an imaging system to image one or more eyes and may generally include a light emitter, which may generate light that is directed to an eye such that light reflected by the eye may be captured by the imaging system. For example, eye-tracking system 130 may include a non-coherent or coherent light source (e.g., a laser diode) emitting light in the visible spectrum or infrared spectrum, and a camera capturing the light reflected by the user's eye. As another example, eye-tracking system 130 may capture reflected radio waves emitted by a miniature radar unit. Eye-tracking system 130 may use low-power light emitters that emit light at frequencies and intensities that would not injure the eye or cause physical discomfort. Eye-tracking system 130 may be arranged to increase contrast in images of an eye captured by eye-tracking system 130 while reducing the overall power consumed by eye-tracking system 130 (e.g., reducing power consumed by a light emitter and an imaging system included in eye-tracking system 130). For example, in some implementations, eye-tracking system 130 may consume less than 100 milliwatts of power.

In some embodiments, eye-tracking system 130 may include one light emitter and one camera to track each of the user's eyes. Eye-tracking system 130 may also include different eye-tracking systems that operate together to provide improved eye tracking accuracy and responsiveness. For example, eye-tracking system 130 may include a fast eye-tracking system with a fast response time and a slow eye-tracking system with a slower response time. The fast eye-tracking system may frequently measure an eye to capture data used by an eye-tracking module 118 to determine the eye's position relative to a reference eye position. The slow eye-tracking system may independently measure the eye to capture data used by eye-tracking module 118 to determine the reference eye position without reference to a previously determined eye position. Data captured by the slow eye-tracking system may allow eye-tracking module 118 to determine the reference eye position with greater accuracy than the eye's position determined from data captured by the fast eye-tracking system. In various embodiments, the slow eye-tracking system may provide eye-tracking data to eye-tracking module 118 at a lower frequency than the fast eye-tracking system. For example, the slow eye-tracking system may operate less frequently or have a slower response time to conserve power.

Eye-tracking system 130 may be configured to estimate the orientation of the user's eye. The orientation of the eye may correspond to the direction of the user's gaze within near-eye display system 120. The orientation of the user's eye may be defined as the direction of the foveal axis, which is the axis between the fovea (an area on the retina of the eye with the highest concentration of photoreceptors) and the center of the eye's pupil. In general, when a user's eyes are fixed on a point, the foveal axes of the user's eyes intersect that point. The pupillary axis of an eye may be defined as the axis that passes through the center of the pupil and is perpendicular to the corneal surface. In general, even though the pupillary axis and the foveal axis intersect at the center of the pupil, the pupillary axis may not directly align with the foveal axis. For example, the orientation of the foveal axis may be offset from the pupillary axis by approximately −1° to 8° laterally and about ±4° vertically (which may be referred to as kappa angles, which may vary from person to person). Because the foveal axis is defined according to the fovea, which is located in the back of the eye, the foveal axis may be difficult or impossible to measure directly in some eye-tracking embodiments. Accordingly, in some embodiments, the orientation of the pupillary axis may be detected and the foveal axis may be estimated based on the detected pupillary axis.

In general, the movement of an eye corresponds not only to an angular rotation of the eye, but also to a translation of the eye, a change in the torsion of the eye, and/or a change in the shape of the eye. Eye-tracking system 130 may also be configured to detect the translation of the eye, which may be a change in the position of the eye relative to the eye socket. In some embodiments, the translation of the eye may not be detected directly, but may be approximated based on a mapping from a detected angular orientation. Translation of the eye corresponding to a change in the eye's position relative to the eye-tracking system due to, for example, a shift in the position of near-eye display system 120 on a user's head, may also be detected. Eye-tracking system 130 may also detect the torsion of the eye and the rotation of the eye about the pupillary axis. Eye-tracking system 130 may use the detected torsion of the eye to estimate the orientation of the foveal axis from the pupillary axis. In some embodiments, eye-tracking system 130 may also track a change in the shape of the eye, which may be approximated as a skew or scaling linear transform or a twisting distortion (e.g., due to torsional deformation). In some embodiments, eye-tracking system 130 may estimate the foveal axis based on some combinations of the angular orientation of the pupillary axis, the translation of the eye, the torsion of the eye, and the current shape of the eye.

In some embodiments, eye-tracking system 130 may include multiple emitters or at least one emitter that can project a structured light pattern on all portions or a portion of the eye. The structured light pattern may be distorted due to the shape of the eye when viewed from an offset angle. Eye-tracking system 130 may also include at least one camera that may detect the distortions (if any) of the structured light pattern projected onto the eye. The camera may be oriented on a different axis to the eye than the emitter. By detecting the deformation of the structured light pattern on the surface of the eye, eye-tracking system 130 may determine the shape of the portion of the eye being illuminated by the structured light pattern. Therefore, the captured distorted light pattern may be indicative of the 3D shape of the illuminated portion of the eye. The orientation of the eye may thus be derived from the 3D shape of the illuminated portion of the eye. Eye-tracking system 130 can also estimate the pupillary axis, the translation of the eye, the torsion of the eye, and the current shape of the eye based on the image of the distorted structured light pattern captured by the camera.

Near-eye display system 120 may use the orientation of the eye to, e.g., determine an inter-pupillary distance (IPD) of the user, determine gaze directions, introduce depth cues (e.g., blur image outside of the user's main line of sight), collect heuristics on the user interaction in the VR media (e.g., time spent on any particular subject, object, or frame as a function of exposed stimuli), some other functions that are based in part on the orientation of at least one of the user's eyes, or some combination thereof. Because the orientation may be determined for both eyes of the user, eye-tracking system 130 may be able to determine where the user is looking. For example, determining a direction of a user's gaze may include determining a point of convergence based on the determined orientations of the user's left and right eyes. A point of convergence may be the point where the two foveal axes of the user's eyes intersect. The direction of the user's gaze may be the direction of a line passing through the point of convergence and the mid-point between the pupils of the user's eyes.

Input/output interface 140 may be a device that allows a user to send action requests to console 110. An action request may be a request to perform a particular action. For example, an action request may be to start or to end an application or to perform a particular action within the application. Input/output interface 140 may include one or more input devices. Example input devices may include a keyboard, a mouse, a game controller, a glove, a button, a touch screen, or any other suitable device for receiving action requests and communicating the received action requests to console 110. An action request received by the input/output interface 140 may be communicated to console 110, which may perform an action corresponding to the requested action. In some embodiments, input/output interface 140 may provide haptic feedback to the user in accordance with instructions received from console 110. For example, input/output interface 140 may provide haptic feedback when an action request is received, or when console 110 has performed a requested action and communicates instructions to input/output interface 140. In some embodiments, imaging device 150 may be used to track input/output interface 140, such as tracking the location or position of a controller (which may include, for example, an IR light source) or a hand of the user to determine the motion of the user. In some embodiments, near-eye display 120 may include one or more imaging devices (e.g., imaging device 150) to track input/output interface 140, such as tracking the location or position of a controller or a hand of the user to determine the motion of the user.

Console 110 may provide content to near-eye display system 120 for presentation to the user in accordance with information received from one or more of imaging device 150, near-eye display system 120, and input/output interface 140. In the example shown in FIG. 1, console 110 may include an application store 112, a headset tracking module 114, an artificial reality engine 116, and eye-tracking module 118. Some embodiments of console 110 may include different or additional modules than those described in conjunction with FIG. 1. Functions further described below may be distributed among components of console 110 in a different manner than is described here.

In some embodiments, console 110 may include a processor and a non-transitory computer-readable storage medium storing instructions executable by the processor. The processor may include multiple processing units executing instructions in parallel. The computer-readable storage medium may be any memory, such as a hard disk drive, a removable memory, or a solid-state drive (e.g., flash memory or dynamic random access memory (DRAM)). In various embodiments, the modules of console 110 described in conjunction with FIG. 1 may be encoded as instructions in the non-transitory computer-readable storage medium that, when executed by the processor, cause the processor to perform the functions further described below.

Application store 112 may store one or more applications for execution by console 110. An application may include a group of instructions that, when executed by a processor, generates content for presentation to the user. Content generated by an application may be in response to inputs received from the user via movement of the user's eyes or inputs received from the input/output interface 140. Examples of the applications may include gaming applications, conferencing applications, video playback application, or other suitable applications.

Headset tracking module 114 may track movements of near-eye display system 120 using slow calibration information from imaging device 150. For example, headset tracking module 114 may determine positions of a reference point of near-eye display system 120 using observed locators from the slow calibration information and a model of near-eye display system 120. Headset tracking module 114 may also determine positions of a reference point of near-eye display system 120 using position information from the fast calibration information. Additionally, in some embodiments, headset tracking module 114 may use portions of the fast calibration information, the slow calibration information, or some combination thereof, to predict a future location of near-eye display system 120. Headset tracking module 114 may provide the estimated or predicted future position of near-eye display system 120 to artificial reality engine 116.

Headset tracking module 114 may calibrate the artificial reality system environment 100 using one or more calibration parameters, and may adjust one or more calibration parameters to reduce errors in determining the position of near-eye display system 120. For example, headset tracking module 114 may adjust the focus of imaging device 150 to obtain a more accurate position for observed locators on near-eye display system 120. Moreover, calibration performed by headset tracking module 114 may also account for information received from IMU 132. Additionally, if tracking of near-eye display system 120 is lost (e.g., imaging device 150 loses line of sight of at least a threshold number of locators 126), headset tracking module 114 may re-calibrate some or all of the calibration parameters.

Artificial reality engine 116 may execute applications within artificial reality system environment 100 and receive position information of near-eye display system 120, acceleration information of near-eye display system 120, velocity information of near-eye display system 120, predicted future positions of near-eye display system 120, or some combination thereof from headset tracking module 114. Artificial reality engine 116 may also receive estimated eye position and orientation information from eye-tracking module 118. Based on the received information, artificial reality engine 116 may determine content to provide to near-eye display system 120 for presentation to the user. For example, if the received information indicates that the user has looked to the left, artificial reality engine 116 may generate content for near-eye display system 120 that reflects the user's eye movement in a virtual environment. Additionally, artificial reality engine 116 may perform an action within an application executing on console 110 in response to an action request received from input/output interface 140, and provide feedback to the user indicating that the action has been performed. The feedback may be visual or audible feedback via near-eye display system 120 or haptic feedback via input/output interface 140.

Eye-tracking module 118 may receive eye-tracking data from eye-tracking system 130 and determine the position of the user's eye based on the eye-tracking data. The position of the eye may include an eye's orientation, location, or both relative to near-eye display system 120 or any element thereof. Because the eye's axes of rotation change as a function of the eye's location in its socket, determining the eye's location in its socket may allow eye-tracking module 118 to more accurately determine the eye's orientation.

In some embodiments, eye-tracking module 118 may store a mapping between images captured by eye-tracking system 130 and eye positions to determine a reference eye position from an image captured by eye-tracking system 130. Alternatively or additionally, eye-tracking module 118 may determine an updated eye position relative to a reference eye position by comparing an image from which the reference eye position is determined to an image from which the updated eye position is to be determined. Eye-tracking module 118 may determine eye position using measurements from different imaging devices or other sensors. For example, eye-tracking module 118 may use measurements from a slow eye-tracking system to determine a reference eye position, and then determine updated positions relative to the reference eye position from a fast eye-tracking system until a next reference eye position is determined based on measurements from the slow eye-tracking system.

Eye-tracking module 118 may also determine eye calibration parameters to improve precision and accuracy of eye tracking. Eye calibration parameters may include parameters that may change whenever a user dons or adjusts near-eye display system 120. Example eye calibration parameters may include an estimated distance between a component of eye-tracking system 130 and one or more parts of the eye, such as the eye's center, pupil, cornea boundary, or a point on the surface of the eye. Other example eye calibration parameters may be specific to a particular user and may include an estimated average eye radius, an average corneal radius, an average sclera radius, a map of features on the eye surface, and an estimated eye surface contour. In embodiments where light from the outside of near-eye display system 120 may reach the eye (as in some augmented reality applications), the calibration parameters may include correction factors for intensity and color balance due to variations in light from the outside of near-eye display system 120. Eye-tracking module 118 may use eye calibration parameters to determine whether the measurements captured by eye-tracking system 130 would allow eye-tracking module 118 to determine an accurate eye position (also referred to herein as “valid measurements”). Invalid measurements, from which eye-tracking module 118 may not be able to determine an accurate eye position, may be caused by the user blinking, adjusting the headset, or removing the headset, and/or may be caused by near-eye display system 120 experiencing greater than a threshold change in illumination due to external light. In some embodiments, at least some of the functions of eye-tracking module 118 may be performed by eye-tracking system 130.

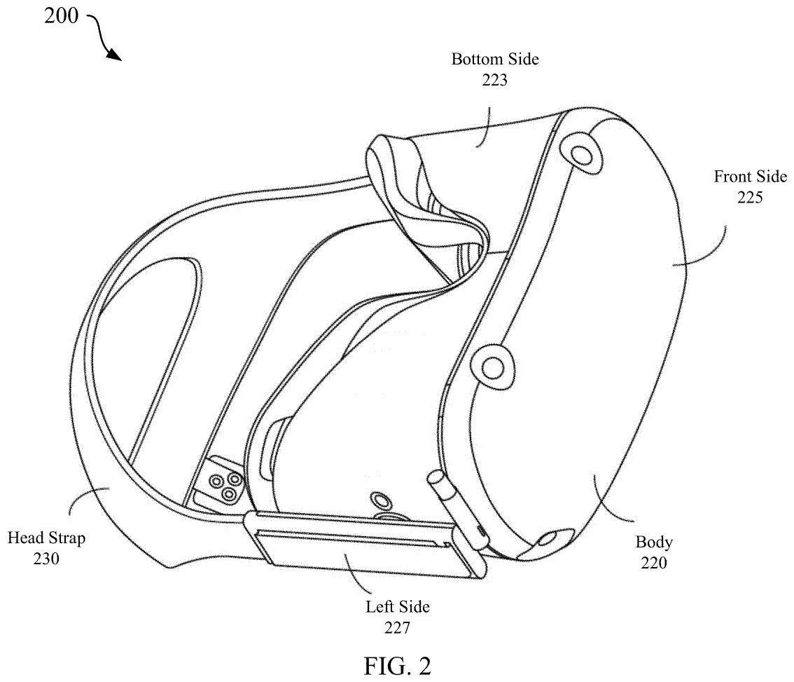

FIG. 2 is a perspective view of an example of a near-eye display system in the form of a head-mounted display (HMD) device 200 for implementing some of the examples disclosed herein. HMD device 200 may be a part of, e.g., a virtual reality (VR) system, an augmented reality (AR) system, a mixed reality (MR) system, or some combinations thereof. HMD device 200 may include a body 220 and a head strap 230. FIG. 2 shows a bottom side 223, a front side 225, and a left side 227 of body 220 in the perspective view. Head strap 230 may have an adjustable or extendible length. There may be a sufficient space between body 220 and head strap 230 of HMD device 200 for allowing a user to mount HMD device 200 onto the user's head. In various embodiments, HMD device 200 may include additional, fewer, or different components. For example, in some embodiments, HMD device 200 may include eyeglass temples and temples tips as shown in, for example, FIG. 2, rather than head strap 230.

HMD device 200 may present to a user media including virtual and/or augmented views of a physical, real-world environment with computer-generated elements. Examples of the media presented by HMD device 200 may include images (e.g., two-dimensional (2D) or three-dimensional (3D) images), videos (e.g., 2D or 3D videos), audios, or some combinations thereof. The images and videos may be presented to each eye of the user by one or more display assemblies (not shown in FIG. 2) enclosed in body 220 of HMD device 200. In various embodiments, the one or more display assemblies may include a single electronic display panel or multiple electronic display panels (e.g., one display panel for each eye of the user). Examples of the electronic display panel(s) may include, for example, a liquid crystal display (LCD), an organic light emitting diode (OLED) display, an inorganic light emitting diode (ILED) display, a micro light emitting diode (mLED) display, an active-matrix organic light emitting diode (AMOLED) display, a transparent organic light emitting diode (TOLED) display, some other display, or some combinations thereof. HMD device 200 may include two eye box regions.

In some implementations, HMD device 200 may include various sensors (not shown), such as depth sensors, motion sensors, position sensors, and eye-tracking sensors. Some of these sensors may use a structured light pattern for sensing. In some implementations, HMD device 200 may include an input/output interface for communicating with a console. In some implementations, HMD device 200 may include a virtual reality engine (not shown) that can execute applications within HMD device 200 and receive depth information, position information, acceleration information, velocity information, predicted future positions, or some combination thereof of HMD device 200 from the various sensors. In some implementations, the information received by the virtual reality engine may be used for producing a signal (e.g., display instructions) to the one or more display assemblies. In some implementations, HMD device 200 may include locators (not shown, such as locators 126) located in fixed positions on body 220 relative to one another and relative to a reference point. Each of the locators may emit light that is detectable by an external imaging device.

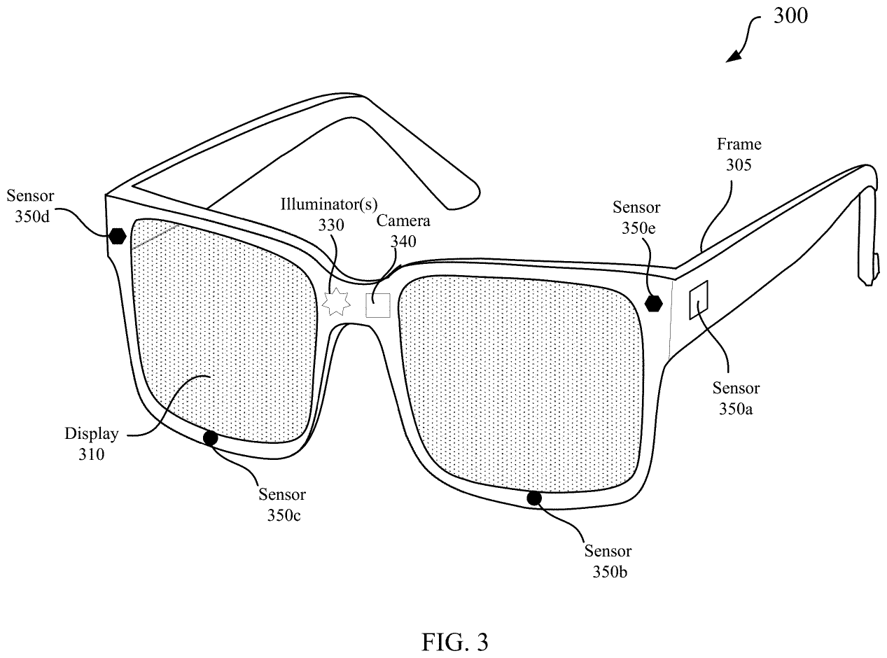

FIG. 3 is a perspective view of an example of a near-eye display system 300 in the form of a pair of glasses for implementing some of the examples disclosed herein. Near-eye display system 300 may be a specific implementation of near-eye display system 120 of FIG. 1, and may be configured to operate as a virtual reality display, an augmented reality display, and/or a mixed reality display. Near-eye display system 300 may include a frame 305 and a display 310. Display 310 may be configured to present content to a user. In some embodiments, display 310 may include display electronics and/or display optics. For example, as described above with respect to near-eye display system 120 of FIG. 1, display 310 may include an LCD display panel, an LED display panel, or an optical display panel (e.g., a waveguide display assembly).

Near-eye display system 300 may further include various sensors 350a, 350b, 350c, 350d, and 350e on or within frame 305. In some embodiments, sensors 350a-350e may include one or more depth sensors, motion sensors, position sensors, inertial sensors, or ambient light sensors. In some embodiments, sensors 350a-350e may include one or more image sensors configured to generate image data representing different fields of views in different directions. In some embodiments, sensors 350a-350e may be used as input devices to control or influence the displayed content of near-eye display system 300, and/or to provide an interactive VR/AR/MR experience to a user of near-eye display system 300. In some embodiments, sensors 350a-350e may also be used for stereoscopic imaging.

In some embodiments, near-eye display system 300 may further include one or more illuminators 330 to project light into the physical environment. The projected light may be associated with different frequency bands (e.g., visible light, infra-red light, ultra-violet light, etc.), and may serve various purposes. For example, illuminator(s) 330 may project light in a dark environment (or in an environment with low intensity of infra-red light, ultra-violet light, etc.) to assist sensors 350a-350e in capturing images of different objects within the dark environment. In some embodiments, illuminator(s) 330 may be used to project certain light pattern onto the objects within the environment. In some embodiments, illuminator(s) 330 may be used as locators, such as locators 126 described above with respect to FIG. 1.

In some embodiments, near-eye display system 300 may also include a high-resolution camera 340. Camera 340 may capture images of the physical environment in the field of view. The captured images may be processed, for example, by a virtual reality engine (e.g., artificial reality engine 116 of FIG. 1) to add virtual objects to the captured images or modify physical objects in the captured images, and the processed images may be displayed to the user by display 310 for AR or MR applications.

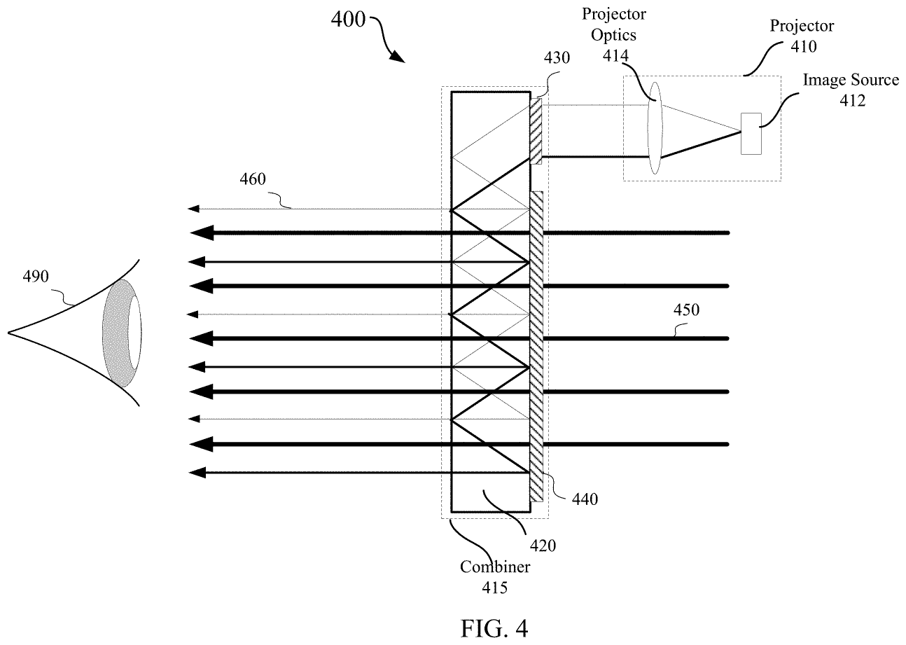

FIG. 4 illustrates an example of an optical see-through augmented reality system 400 using a waveguide display according to certain embodiments. Augmented reality system 400 may include a projector 410 and a combiner 415. Projector 410 may include a light source or image source 412 and projector optics 414. In some embodiments, image source 412 may include a plurality of pixels that displays virtual objects, such as an LCD display panel or an LED display panel. In some embodiments, image source 412 may include a light source that generates coherent or partially coherent light. For example, image source 412 may include a laser diode, a vertical cavity surface emitting laser, and/or a light emitting diode. In some embodiments, image source 412 may include a plurality of light sources each emitting a monochromatic image light corresponding to a primary color (e.g., red, green, or blue). In some embodiments, image source 412 may include an optical pattern generator, such as a spatial light modulator. Projector optics 414 may include one or more optical components that can condition the light from image source 412, such as expanding, collimating, scanning, or projecting light from image source 412 to combiner 415. The one or more optical components may include, for example, one or more lenses, liquid lenses, mirrors, apertures, and/or gratings. In some embodiments, projector optics 414 may include a liquid lens (e.g., a liquid crystal lens) with a plurality of electrodes that allows scanning of the light from image source 412.

Combiner 415 may include an input coupler 430 for coupling light from projector 410 into a substrate 420 of combiner 415. Combiner 415 may transmit at least 50% of light in a first wavelength range and reflect at least 25% of light in a second wavelength range. For example, the first wavelength range may be visible light from about 400 nm to about 650 nm, and the second wavelength range may be in the infrared band, for example, from about 800 nm to about 1000 nm. Input coupler 430 may include a volume holographic grating, a diffractive optical elements (DOE) (e.g., a surface-relief grating), a slanted surface of substrate 420, or a refractive coupler (e.g., a wedge or a prism). Input coupler 430 may have a coupling efficiency of greater than 30%, 50%, 75%, 90%, or higher for visible light. Light coupled into substrate 420 may propagate within substrate 420 through, for example, total internal reflection (TIR). Substrate 420 may be in the form of a lens of a pair of eyeglasses. Substrate 420 may have a flat or a curved surface, and may include one or more types of dielectric materials, such as glass, quartz, plastic, polymer, poly (methyl methacrylate) (PMMA), crystal, or ceramic. A thickness of the substrate may range from, for example, less than about 1 mm to about 10 mm or more. Substrate 420 may be transparent to visible light. In some embodiments, substrate 420 is referred to as a waveguide.

Substrate 420 may include or may be coupled to a plurality of output couplers 440 configured to extract at least a portion of the light guided by and propagating within substrate 420 from substrate 420, and direct extracted light 460 to an eye 490 of the user of augmented reality system 400. As input coupler 430, output couplers 440 may include grating couplers (e.g., volume holographic gratings or surface-relief gratings), other DOEs, prisms, etc. Output couplers 440 may have different coupling (e.g., diffraction) efficiencies at different locations. Substrate 420 may also allow light 450 from environment in front of combiner 415 to pass through with little or no loss. Output couplers 440 may also allow light 450 to pass through with little loss. For example, in some implementations, output couplers 440 may have a low diffraction efficiency for light 450 such that light 450 may be refracted or otherwise pass through output couplers 440 with little loss, and thus may have a higher intensity than extracted light 460. In some implementations, output couplers 440 may have a high diffraction efficiency for light 450 and may diffract light 450 to certain desired directions (i.e., diffraction angles) with little loss. As a result, the user may be able to view combined images of the environment in front of combiner 415 and virtual objects projected by projector 410.

In addition, as described above, in an artificial reality system, to improve user interaction with presented content, the artificial reality system may track the user's eye and modify or generate content based on a location or a direction in which the user is looking at. Tracking the eye may include tracking the position and/or shape of the pupil and/or the cornea of the eye, and determining the rotational position or gaze direction of the eye. One technique (referred to as Pupil Center Corneal Reflection or PCCR method) involves using NIR LEDs to produce glints on the eye cornea surface and then capturing images/videos of the eye region. Gaze direction can be estimated from the relative movement between the pupil center and glints. Various holographic optical elements may be used in an eye-tracking system for illuminating the user's eyes or collecting light reflected by the user's eye.

One example of the holographic optical elements may be a holographic volume Bragg grating, which may be recorded on a holographic material layer by exposing the holographic material layer to light patterns generated by the interference between two or more coherent light beams.

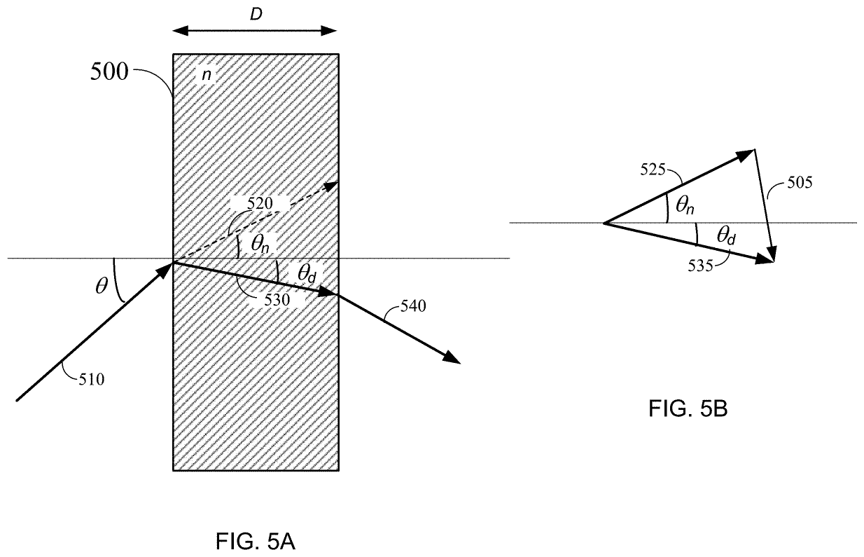

FIG. 5A illustrates an example of a volume Bragg grating (VBG) 500. Volume Bragg grating 500 shown in FIG. 5A may include a transmission holographic grating that has a thickness D. The refractive index n of volume Bragg grating 500 may be modulated at an amplitude n₁, and the grating period of volume Bragg grating 500 may be Λ. Incident light 510 having a wavelength λ may be incident on volume Bragg grating 500 at an incident angle θ, and may be refracted into volume Bragg grating 500 as incident light 520 that propagates at an angle θₙ in volume Bragg grating 500. Incident light 520 may be diffracted by volume Bragg grating 500 into diffraction light 530, which may propagate at a diffraction angle θ_{d} in volume Bragg grating 500 and may be refracted out of volume Bragg grating 500 as diffraction light 540.

FIG. 5B illustrates the Bragg condition for volume Bragg grating 500 shown in FIG. 5A. Vector 505 represents the grating vector \vec{G}, where |\vec{G}|=2π/Λ. Vector 525 represents the incident wave vector \vec{kᵢ} and vector 535 represents the diffract wave vector \vec{k_{d}}, where |\vec{kᵢ}|=|\vec{k_{d}}|=2πn/λ. Under the Bragg phase-matching condition, \vec{kᵢ}−\vec{k_{d}}=\vec{G}. Thus, for a given wavelength λ, there may only be one pair of incident angle B (or θₙ) and diffraction angle θ_{d} that meet the Bragg condition perfectly. Similarly, for a given incident angle θ, there may only be one wavelength λ that meets the Bragg condition perfectly. As such, the diffraction may only occur in a small wavelength range and a small incident angle range. The diffraction efficiency, the wavelength selectivity, and the angular selectivity of volume Bragg grating 500 may be functions of thickness D of volume Bragg grating 500. For example, the full-width-half-magnitude (FWHM) wavelength range and the FWHM angle range of volume Bragg grating 500 at the Bragg condition may be inversely proportional to thickness D of volume Bragg grating 500, while the maximum diffraction efficiency at the Bragg condition may be a function sin²(a×n₁×D), where a is a coefficient. For a reflection volume Bragg grating, the maximum diffraction efficiency at the Bragg condition may be a function of tan h² (a×n₁×D)

In some embodiments, a multiplexed Bragg grating may be used to achieve a desired optical performance, such as a high diffraction efficiency and large field of view (FOV) for the full visible spectrum (e.g., from about 400 nm to about 700 nm, or from about 440 nm to about 650 nm). Each part of the multiplexed Bragg grating may be used to diffract light from a different FOV range and/or within a different wavelength range. Thus, in some designs, multiple volume Bragg gratings each recorded under a different recording condition may be used.

The holographic optical elements (HOEs) described above may be recorded in a holographic material (e.g., photopolymer) layer. In some embodiments, the HOEs can be recorded first and then laminated on a substrate in a near-eye display system. In some embodiments, a holographic material layer may be coated or laminated on the substrate and the HOEs may then be recorded in the holographic material layer.

In general, to record a holographic optical element in a photosensitive material layer, two coherent beams may interfere with each other at certain angles to generate a unique interference pattern in the photosensitive material layer, which may in turn generate a unique refractive index modulation pattern in the photosensitive material layer, where the refractive index modulation pattern may correspond to the light intensity pattern of the interference pattern. The photosensitive material layer may include, for example, silver halide emulsion, dichromated gelatin, photopolymers including photo-polymerizable monomers suspended in a polymer matrix, photorefractive crystals, and the like.

In one example, the photosensitive material layer may include two-stage photopolymers. The two-stage photopolymers may include polymeric binders, writing monomers (e.g., acrylic monomers), and initiating agents, such as photosensitizing dyes, initiators, and/or chain transfer agents. The polymeric binders may act as the backbone or the support matrix. For example, the polymeric binders may include a low refractive index (e.g., <1.5) rubbery polymer (e.g., a polyurethane), which may be thermally cured at the first stage to provide mechanical support during the holographic exposure and ensure the refractive index modulation is permanently preserved. The writing monomers and the initiating agents may be dissolved in the support matrix. The writing monomers may serve as refractive index modulators. For example, the writing monomers may include high index acrylate monomers which can react with photoinitiators and polymerize. In the second stage, the photosensitizing dyes may absorb light and interact with the initiators to produce radicals (or acids). The radicals (or acids) may initiate the polymerization by adding monomers to the ends of chains of monomers to polymerize the monomers.

During the recording process (e.g., the second stage), the interference pattern may cause the generation of the radicals or acids in the bright fringes, which may in turn cause the polymerization of the monomers in the bright fringes. While the monomers in the bright fringes are consumed, monomers in the unexposed dark region may diffuse to the bright fringes to enhance the polymerization. As a result, polymerization concentration and density gradients may be formed in the photosensitive material layer, resulting in refractive index modulation in the photosensitive material layer due to the higher refractive index of the writing monomers. For example, areas with a higher concentration of monomers and polymerization may have a higher refractive index. As the exposure and polymerization proceed, fewer monomers may be available for diffusion and polymerization, and thus the diffusion and polymerization may be suppressed. After all or substantially all monomers have been polymerized, no more new holographic optical elements (e.g., gratings) may be recorded in the photosensitive material layer.

In some embodiments, the recorded holographic optical elements in the photosensitive material layer may be UV cured or thermally cured or enhanced, for example, for dye bleaching, completing polymerization, permanently fixing the recorded pattern, and enhancing the refractive index modulation. At the end of the process, a holographic optical element, such as a holographic grating, may be formed. The holographic grating can be a volume Bragg grating with a thickness of, for example, a few, or tens, or hundreds of microns.

To generate the desired light interference pattern for recording the HOEs, two or more coherent beams may generally be used, where one beam may be a reference beam and another beam may be an object beam that may have a desired wavefront profile. When the recorded HOEs are illuminated by the reference beam, the object beam with the desired wavefront profile may be reconstructed.

In some embodiments, the holographic optical elements may be used to diffract light outside of the visible band. For example, IR light or NIR light (e.g., at 940 nm or 850 nm) may be used for eye-tracking. Thus, the holographic optical elements may need to diffract IR or NIR light, but not the visible light. However, there may be very few holographic recording materials that are sensitive to infrared light. As such, to record a holographic grating that can diffract infrared light, recording light at a shorter wavelength (e.g., in visible or UV band, such as at about 660 nm, about 532 nm, about 514 nm, or about 457 nm) may be used, and the recording condition (e.g., the angles of the two interfering coherent beams) may be different from the reconstruction condition.

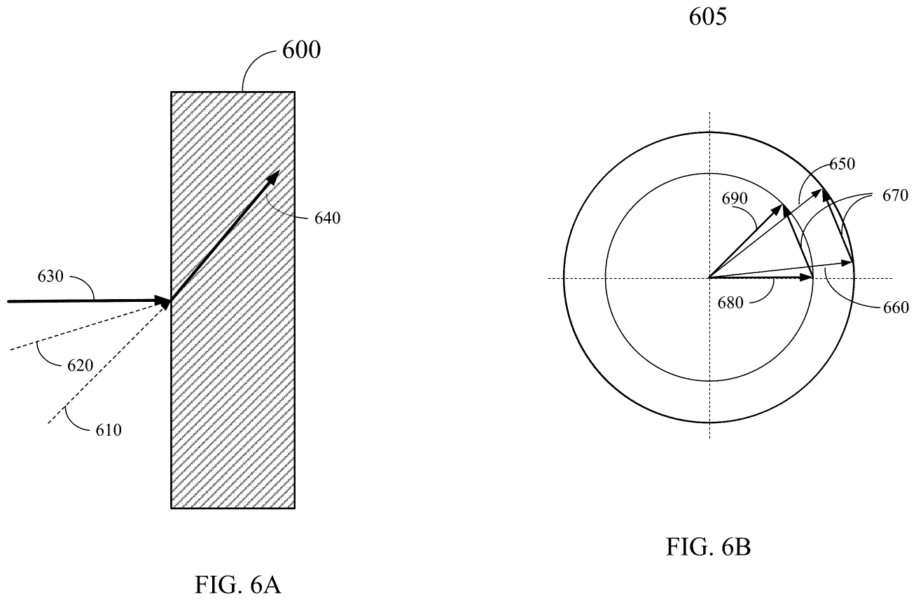

FIG. 6A illustrates the recording light beams for recording a volume Bragg grating 600 and the light beam reconstructed from volume Bragg grating 600 according to certain embodiments. In the example illustrated, volume Bragg grating 600 may include a transmission volume hologram recorded using reference beam 620 and object beam 610 at a first wavelength, such as 660 nm. When a light beam 630 at a second wavelength (e.g., 940 nm) is incident on volume Bragg grating 600 at a 0° incident angle, the incident light beam 630 may be diffracted by volume Bragg grating 600 at a diffraction angle as shown by a diffracted beam 640.

FIG. 6B is an example of a holography momentum diagram 605 illustrating the wave vectors of recording beams and reconstruction beams and the grating vector of the recorded volume Bragg grating according to certain embodiments. FIG. 6B shows the Bragg matching conditions during the holographic grating recording and reconstruction. The length of wave vectors 650 and 660 of the recording beams (e.g., object beam 610 and reference beam 620) may be determined based on the recording light wavelength λ_{c} (e.g., 660 nm) according to 2πn/λ_{c}, where n is the average refractive index of holographic material layer. The directions of wave vectors 650 and 660 of the recording beams may be determined based on the desired grating vector K (670) such that wave vectors 650 and 660 and grating vector K (670) can form an isosceles triangle as shown in FIG. 6B. Grating vector K may have an amplitude 2π/Λ, where Λ is the grating period. Grating vector K may in turn be determined based on the desired reconstruction condition. For example, based on the desired reconstruction wavelength λᵣ (e.g., 940 nm) and the directions of the incident light beam (e.g., light beam 630 at 0°) and the diffracted light beam (e.g., diffracted beam 640), grating vector K (670) of volume Bragg grating 600 may be determined based on the Bragg condition, where wave vector 680 of the incident light beam (e.g., light beam 630) and wave vector 690 of the diffracted light beam (e.g., diffracted beam 640) may have an amplitude 2πn/λᵣ, and may form an isosceles triangle with grating vector K (670) as shown in FIG. 6B.

For a given wavelength, there may only be one pair of incident angle and diffraction angle that meet the Bragg condition perfectly. Similarly, for a given incident angle, there may only be one wavelength that meets the Bragg condition perfectly. When the incident angle of the reconstruction light beam is different from the incident angle that meets the Bragg condition of the volume Bragg grating or when the wavelength of the reconstruction light beam is different from the wavelength that meets the Bragg condition of the volume Bragg grating, the diffraction efficiency may be reduced as a function of the Bragg mismatch factor caused by the angular or wavelength detuning from the Bragg condition. As such, the diffraction may only occur in a small wavelength range and a small incident angle range.

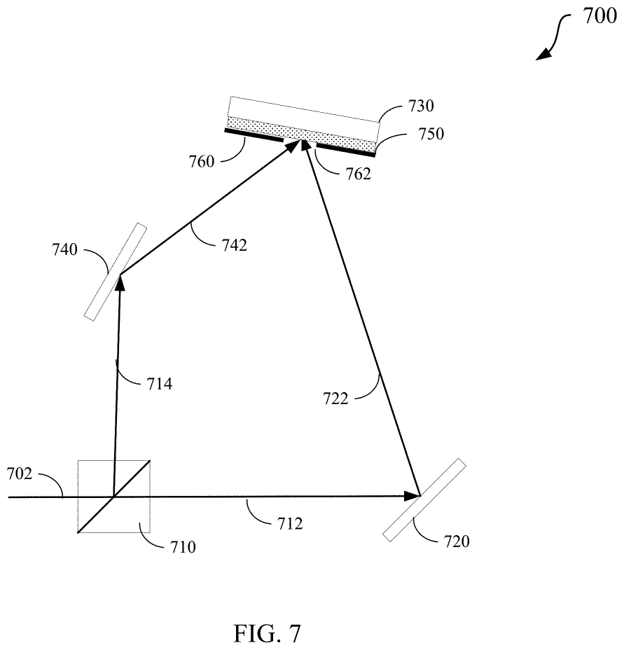

FIG. 7 illustrates an example of a holographic recording system 700 for recording holographic optical elements according to certain embodiments. Holographic recording system 700 includes a beam splitter 710 (e.g., a beam splitter cube), which may split an incident laser beam 702 into two light beams 712 and 714 that are coherent and may have similar intensities. Light beam 712 may be reflected by a first mirror 720 towards a plate 730 as shown by the reflected light beam 722. On another path, light beam 714 may be reflected by a second mirror 740. The reflected light beam 742 may be directed towards plate 730, and may interfere with light beam 722 at plate 730 to generate an interference pattern. A holographic recording material layer 750 may be formed on plate 730 or on a substrate mounted on plate 730. The interference pattern may cause the holographic optical element to be recorded in holographic recording material layer 750 as described above. In some embodiments, plate 730 may also be a mirror.

In some embodiments, a mask 760 may be used to record different HOEs at different regions of holographic recording material layer 750. For example, mask 760 may include an aperture 762 for the holographic recording and may be moved to place aperture 762 at different regions on holographic recording material layer 750 to record different HOEs at the different regions using different recording conditions (e.g., recording beams with different angles).

Holographic materials can be selected for specific applications based on some parameters of the holographic material, such as the spatial frequency response, dynamic range, photosensitivity, physical dimensions, mechanical properties, wavelength sensitivity, and development or bleaching method for the holographic material.

The dynamic range indicates how much refractive index change can be achieved in a holographic material. The dynamic range may affect the thickness of the device for high efficiency and the number of holograms that can be multiplexed in the holographic material. The dynamic range may be represented by the refractive index modulation (RIM), which may be one half of the total change in refractive index. Small values of refractive index modulation may be given as parts per million (ppm). In generally, a large refractive index modulation in the holographic optical elements is desired in order to improve the diffraction efficiency and record multiple holographic optical elements in a same holographic material layer.

The frequency response is a measure of the feature size that the holographic material can record and may dictate the types of Bragg conditions can be achieved. The frequency response can be characterized by a modulation transfer function, which may be a curve depicting the visibility of sine waves of varying frequencies. In general, a single frequency value may be used to represent the frequency response, which may indicate the frequency value at which the modulation begins to drop or at which the modulation is reduced by 3 dB. The frequency response may also be represented by lines/mm, line pairs/mm, or the period of the sinusoid.

The photosensitivity of the holographic material may indicate the photo-dosage required to achieve a certain efficiency, such as 100% or 1% (for photo-refractive crystals). The physical dimensions that can be achieved in a particular medium affect the aperture size as well as the spectral selectivity of the device. Physical parameters of holographic materials may be related to damage thresholds and environmental stability. The wavelength sensitivity may be used to select the light source for the recording setup and may also affect the minimum achievable period. Some materials may be sensitive to light in a wide wavelength range. Development considerations may include how the holographic material is processed after recording. Many holographic materials may need post-exposure development or bleaching.

Different Resins on Same Substrate

It can be difficult to design a single photopolymer material that meets many technical requirements (e.g., high dynamic range, low absorption & haze, good resolution at high & low spatial frequencies, sensitivity across visible spectrum, etc.). It can be especially difficult to design a single resin that is capable of patterning large pitch & small pitch features (e.g., due to reaction/diffusion mechanisms inherent to materials used). In some embodiments, different resins are deposited on the same substrate to make a single film with spatially varying properties. For example, absorption, spatial frequency response, etc. of the single film can vary as a function of position.

Referring to FIG. 8, a simplified diagram of an embodiment of a dispenser 804 depositing drops of a first material 808 on a substrate 812 is shown. The first material 808 has a first material property. The first material 808 is deposited onto the substrate 812 to form a first pattern on the substrate 812. The dispenser 804 is part of an inkjet. The substrate 812 is flat (e.g., having a surface parallel to an x/y plane) and thin (e.g., a thickness measured in the z-dimension being less than half and/or a quarter of a length of the substrate 812 measured in the x-dimension). In some embodiments, the substrate 812 is a semiconductor substrate (e.g., a silicon substrate).

In some embodiments, the first material 808 comprises a first matrix, a first monomer, and a first photoinitiator. The first matrix can be a resin (e.g., a jettable resin). For example the first matrix could be a low refractive index, rubbery polymer (like polyurethane), which can be thermally cured to provide mechanical support during holographic exposure. The thermal cure can be a first stage cure and exposing the first material to light can be a second stage cure. The first monomer is a writing monomer configured to polymerize based on a reaction with the first photoinitiator. In some embodiments, the first monomer is a high index acrylate monomer. High refractive index can be high relative to matrix material. For example, for a polyurethane matrix the first monomer can have a refractive index of about 1.5. A high refractive index monomer can have a refractive index equal to or greater than 1.48, 1.5, 1.55, or 1.6 and/or equal to or less 1.7, 1.8, or 2.0. Low refractive index can be equal to or greater than 1.3 or 1.35 and/or equal to or less than 1.47, 1.45, or 1.40. The first photoinitiator can comprise one or more compounds. For example, two compounds (e.g., (1) dye or sensitizer; and (2) a coinitiator) can be used for visible light polymerization (e.g., the dye/sensitizer absorbs light and transfers energy or some reactive species to the coinitiator that initiates polymerization).

The first material is characterized by a first diffusion coefficient of the first monomer in the first matrix. The first diffusion coefficient can be relatively high (e.g., allowing for writing of larger features; lower spatial frequency response). In some embodiments, a high diffusion coefficient is equal to or greater than 0.5 or 1 μm²/s and/or equal to or less than 6 or 10 μm²/s. The first pattern can be for areas on the substrate 812 where gratings having large pitch can be patterned. In some embodiments, large pitch is equal to or greater than 500, 600, or 800 nm and/or equal to or less than 1500, 1700, or 2000 nm. In some embodiments, for large-pitch gratings, an amount of crosslinking/multifunctional monomer in a formulation is reduced compared to a formulation for small-pitch gratings; and/or an amount of crosslinking/multifunctional monomer is increased in a formulation for small-pitch gratings compared to a formulation for large-pitch gratings.

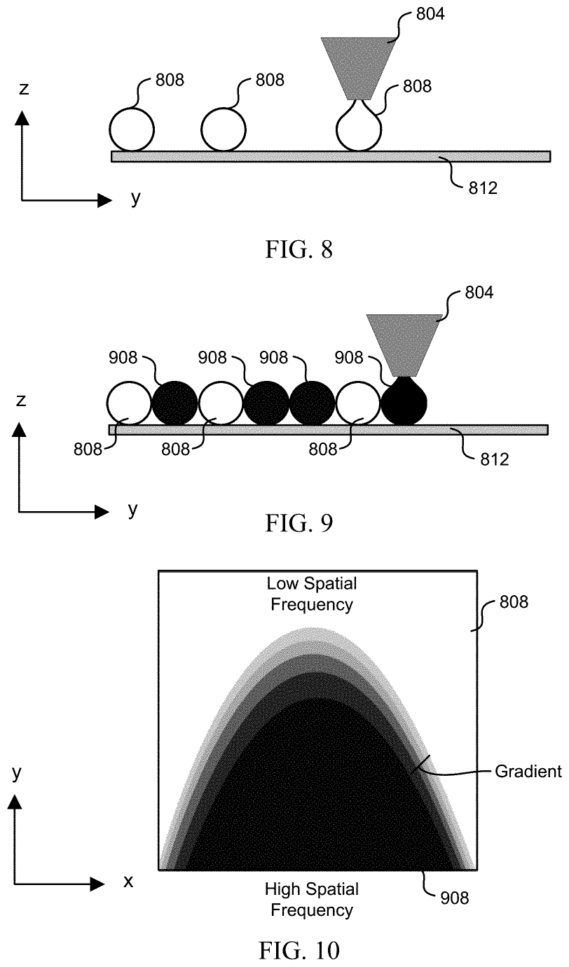

FIG. 9 is a simplified diagram of an embodiment of the dispenser 804 depositing drops of a second material 908 on the substrate 812. The second material has a second material property. The second material 908 can be a resin (e.g., a jettable resin). The second material 908 is deposited onto the substrate 812 to form a second pattern on the substrate 812.

In some embodiments, the second material 908 comprises a second matrix, a second monomer, and a second photoinitiator. The second matrix can be a resin (e.g., a low refractive index, rubbery polymer). The second monomer is a writing monomer configured to polymerize based on a reaction with the second photoinitiator. In some embodiments, the second monomer is a high index acrylate monomer. The second photoinitiator can comprise one or more compounds.

The second material is characterized by a second diffusion coefficient of the second monomer in the second matrix. For example, the second matrix can restrict movement of the second monomer. In some embodiments, the second monomer is the same as the first monomer and/or the second photoinitiator is the same as the first photoinitiator. The second diffusion coefficient can be relatively low (e.g., allowing for writing of smaller features; higher spatial frequency response). In some embodiments, a low diffusion coefficient is equal to or greater than 0.001, 0.01, or 0.05 μm²/s and/or equal to or less than 0.5, 0.25, or 0.2 μm²/s. The second pattern can be for areas on the substrate 812 where gratings having small pitch can be patterned. In some embodiments small pitch is equal to or greater than 100, 120, or 150 nm and/or equal to or less than 300, 400, 500, or 600 nm.

FIG. 10 illustrates a top view of spatial frequency response of an embodiment of an optical device (e.g., output coupler 440). The spatial frequency response varies as a function of x and y. The function, in FIG. 10, is a gradient along a parabolic-type curve. The gradient is formed by a combination of the first material and the second material (e.g., the second pattern is a parabola with lowing concentration of the second material in the y direction). Other patterns could be created. In some embodiments, the optical device is created using the dispenser 804. The first material has a lower spatial frequency response than the second material (e.g., because of the higher diffusion coefficient of the first material). Drops of the first material 808 and drops of the second material 908 are dispensed to different x,y locations on the same substrate.

In some embodiments, a planarization step mixes drops of the first material and drops of the second material. Chemistry of the first matrix and the second matrix can be tuned such that bulk refractive indices are almost identical (e.g., less than 0.005 or 0.001 difference). In regions where the first material and the second material meet, a concentration gradient can exist where small differences in optical properties are smoothed out over large areas. In some embodiments, a large distance is equal to or greater than 0.5 or 1.0 mm and/or equal to or less than 3, 4, or 5 mm.

Though some embodiments describe a change in spatial frequency response, holographic materials (e.g., the first material and the second material) can be selected for specific applications based on some parameters of the holographic material, instead of, or in addition to spatial frequency response (e.g., such as dynamic range of refractive index, photosensitivity, physical dimensions, mechanical properties, wavelength sensitivity, and/or development or bleaching method for the holographic material).

In some embodiments, a device comprises a first holographic recording material (e.g., the first material 808) and a second holographic recording material (e.g., the second material 908). The first holographic recording material is disposed on a substrate (e.g., substrate 812), wherein the first holographic recording material comprises a first optical element (e.g., a grating with a first pitch). The second holographic recording material is disposed on the substrate, wherein the second holographic recording material comprises a second optical element (e.g., a grating with a second pitch), and the second optical element is smaller in size than the first optical element based on a property of the second holographic recording material compared to a property of the first holographic recording material. The second pitch is smaller than the first pitch because the spatial frequency response of the first holographic recording material is lower than the spatial frequency response of the second holographic recording material.

Different materials support formation of different feature sizes. A feature is a distinct portion of an element. Examples of features include a width of a surface and height of a wall. A first material could be limited to optical elements having a feature sizes equal to or greater than 0.8 micron, and a second material could be limited to optical elements having feature sizes equal to or greater than 0.5 microns. Thus, smaller features can be formed in the second material compared to the first material. A second optical element that is smaller in size than a first optical element can refer to the second optical element having a feature size that is smaller than a feature size of the first optical element. In gratings, an example of a feature size is grooves per millimeter, where a second grating being smaller in size to a first grating corresponds to the second grating having more grooves per millimeter than the first grating.

A refractive index of the first holographic recording material can be substantially the same as a refractive index of the second holographic recording material (e.g., the second matrix has a refractive index that is substantially the same as the first matrix and/or a refractive index of the first monomer is substantially the same as a refractive index of the second monomer; to make a single film with substantially the same refractive index on the substrate 812). In some embodiments, refractive indices that are substantially the same have a difference equal to or less than 0.003 or 0.001. Optical elements can include volume Bragg gratings (e.g., for output couplers or output couplers of waveguides using in an artificial-reality display). The first holographic recording material can be disposed on the substrate in a first pattern that at least partially overlaps a second pattern of the second holographic recording material disposed on the substrate (e.g., as described in FIGS. 8-10).

Different Resins on Different Substrates

Different materials can be applied to different substrates in lieu of, or in addition to, applying multiple materials to one substrate. It can be difficult to design a single photopolymer material that meets many technical requirements (e.g., high dynamic range, low absorption & haze, good resolution at high & low spatial frequencies, sensitivity across visible spectrum, etc.). It can be especially difficult to design a single resin that is capable of patterning large pitch & small pitch features, due to reaction/diffusion mechanisms inherent to materials used. In some embodiments, different films are deposited on different substrates. The different substrates can be combined either before or after exposure to make a single device.

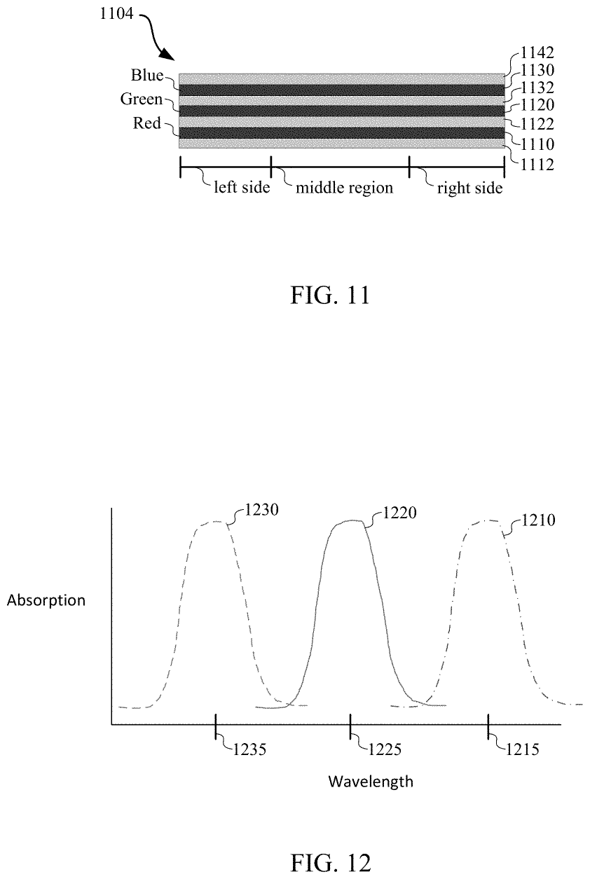

Referring to FIG. 11, a simplified diagram of an embodiment of a stack 1104 of different resins on different substrates to form an optical device is shown. A first film 1110 is deposited on a first substrate 1112; a second film 1120 is deposited on a second substrate 1122; a third film 1130 is deposited on a third substrate 1132; and a fourth substrate 1142 is on top of the third film 1130. The first film 1110, the second film 1120, and the third film 1130 each comprise a matrix, a monomer, and a photoinitiator. The first film 1110, the second film 1120, and/or the third film 1130 can be designed to have different properties. For example, photoinitiators can be tuned to absorb different wavelengths of light. Though three films are shown in stack 1104, other numbers of films could be used (e.g., 2, 4, 5, 6, etc.). The first substrate 1112 spatially overlaps the second substrate 1122, the third substrate 1132, and the fourth substrate 1142 (e.g., optical axes of substrates are collinear; in some embodiments, there could be partial overlap). In some embodiments, the first film 1110 has a matrix and monomer similar to the first matrix and first monomer of the first material 808 in FIG. 8, and/or the second film 1120 has a matrix and monomer similar to the second matrix and the second monomer of the second material 908 of FIG. 9.

FIG. 12 is a chart of optical absorption of embodiments of different resins of the stack 1104. A first photoinitiator of the first film 1110 is tuned to have a first absorption band 1210 centered at a first wavelength 1215. A second photoinitiator of the second film 1120 is tuned to have a second absorption band 1220 centered at a second wavelength 1225. A third photoinitiator of the third film 1130 is tuned to have a third absorption band 1230 centered at a third wavelength 1235. In some embodiments, a bandwidth of an absorption band is measured at full-width, half-max of the absorption band. In some embodiments, the first film 1110 has a lower spatial frequency response than the second film 1120 (e.g., as described in FIGS. 8-10); and/or the third film 1130 has a higher frequency response than the second film 1120. Accordingly, smaller optical elements can be written in the second film 1120 than the first film 1110; and/or even smaller optical elements can be written in the third film 1130 than the second film 1120.

In the example shown, absorption of each film (e.g., resin) in the stack 1104 is tuned to respond to a different wavelength in the visible region (e.g., between 400-700 nm). Substrates in the stack 1104 are transparent to visible light. By selecting exposure light to match a photoinitiator in a resin, only one film in the stack 1104 can be configured to respond to an exposure. This allows different optical patterns to be recorded spatially in different films with different wavelengths of exposure light. For example, the first wavelength 1215 is in the red region of the visible spectrum (e.g., between 625 and 700 nm; between 655 and 680; 660, 656.5, 671 nm using frequency-doubled solid-state lasers); the second wavelength 1225 is in the green region of the visible spectrum (e.g., between 515 and 560 nm; 515, 532 nm using frequency-doubled solid-state lasers); and the third wavelength 1235 is in the blue region of the visible spectrum (e.g., between 440 and 490 nm; 457, 465, 473 nm using frequency-doubled solid-state lasers). The stack 1104 is exposed sequentially, or concurrently, to red, green, and blue light to form optical elements in the first film 1110, the second film 1120, and the third film 1130. Red light is used to form optical elements in the first film 1110 (the second film 1120 and the third film 1130 do not respond to red light because red light is outside the second absorption band 1220 and outside the third absorption band 1230); green light is used to form optical elements in the second film 1120 (the first film 1110 and the third film 1130 do not respond to green light because green light is outside the first absorption band 1210 and outside the third absorption band 1230); blue light is used to form optical elements in the third film 1130 (the first film 1110 and the second film 1120 do not respond to blue light because blue light is outside the first absorption band 1210 and outside the second absorption band 1220).

If photoinitiators of the first film 1110, the second film 1120, and the third film 1130 were combined into the same film (e.g., onto one substrate), optical thickness could be much greater, which could cause a loss of fringe contrast during exposure and/or less refractive index dynamic range (e.g., lower Δn); and if photoinitiator concentration were reduced to have the same optical thickness as the stack 1104, then Δn may also decrease, as the film will be less sensitive to exposure. For example, optical thickness could be too great if transmission measured at the exposure wavelength is equal to or less than 20%.

In some embodiments, different areas of different films are used. For example, optical elements in the first film 1110 are written in a left side of the stack 1104; optical elements written in the second film 1120 are written in a middle region of the stack 1104; and optical elements written in the third film 1130 are written in a right side of the stack 1104, such that optical elements written in the first film 1110 do not overlap optical elements written in the third film 1130 (though there may be some overlap of optical elements in the first film 1110 and the second film 1120 and some overlap of optical elements in the second film 1120 and the third film 1130.

In some embodiments, an optical device comprises a first substrate; a second substrate; a first holographic recording film having a first optical element recorded in the first holographic recording film, the first holographic recording film disposed on the first substrate; and a second holographic recording film having a second optical element recorded in the second holographic recording film disposed on the second substrate. The second substrate spatially overlaps the first substrate forming a stack. The stack is configured to couple light out of a (e.g., one) waveguide.

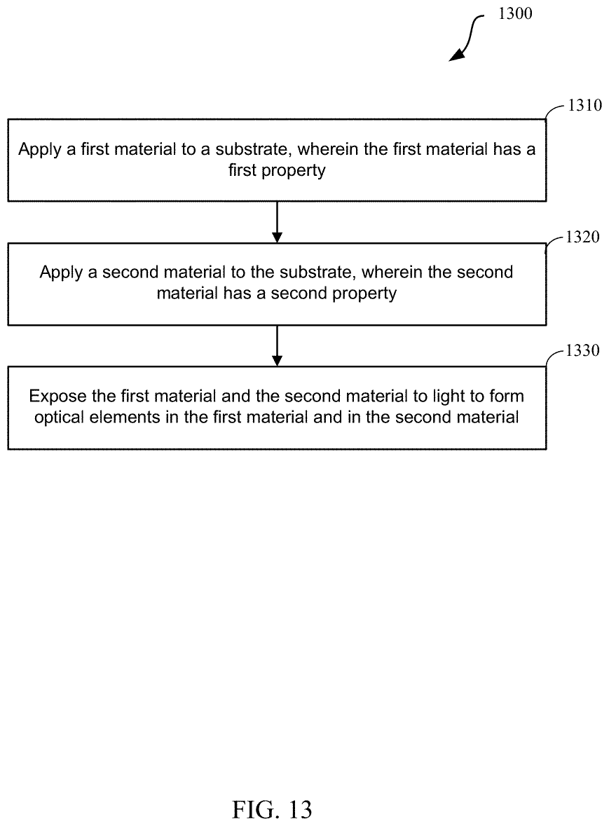

FIG. 13 is a simplified flow chart 1300 illustrating an example of a method of applying two materials to one substrate according to certain embodiments. The operations described in flow chart 1300 are for illustration purposes only and are not intended to be limiting. In various implementations, modifications may be made to flow chart 1300 to add additional operations, omit some operations, combine some operations, split some operations, or reorder some operations.

At block 1310, a first material is applied to a substrate, wherein the first material has a first property. For example, the first material is the first material in FIG. 8 having a high diffusion coefficient of a first monomer in a first matrix.

At block 1320, a second material is applied to the substrate, wherein the second material has a second property. For example, the second material is the second material in FIG. 9 having a low diffusion coefficient of a second monomer in a second matrix.

At block 1330, the first material and the second material are exposed to light. By exposing the first material and the second material to light, optical elements can be formed in the first material and in the second material. Exposure to light can include using a mask. The second material can be exposed to light concurrently or after exposing the first material to light.

In some embodiments, the method further comprises designing the first material and designing the second material. A method can comprise applying a first material to a substrate, wherein: the first material comprises a first matrix, a first monomer, and a first photoinitiator; the first monomer is a writing monomer configured to polymerize based on a reaction with the first photoinitiator; and the first material is characterized by a first diffusion coefficient of the first monomer in the first matrix; applying a second material to the substrate, wherein: the second material comprises a second matrix, a second monomer, and a second photoinitiator; the second monomer is a writing monomer configured to polymerize based on a reaction with the second photoinitiator; the second material is characterized by a second diffusion coefficient of the second monomer in the second matrix; and the second diffusion coefficient is less than the first diffusion coefficient; and exposing the first material and the second material to light to form optical elements in the first material and in the second material. The first matrix can have a first refractive index; the second matrix can have a second refractive index; and the first refractive index is substantially the same as the second refractive index. There can be less than a 0.001 difference between the first refractive index and the second refractive index. Optical elements can be a first grating with a first pitch in the first material and a second grating with a second pitch in the second material. The first pitch can be larger than the second pitch based on higher diffusivity of the first material (e.g., high diffusivity of the first material provides a lower spatial frequency response for forming larger elements in the first material and smaller elements in the second material). The first matrix and the second matrix are resins while applied to the substrate. The first material and the second material can be deposited on the substrate to form a concentration gradient of the first material and the second material (e.g., as shown in FIG. 10). The first material and the second material can be holographic recording materials and/or optical elements can comprise a volume Bragg grating.

In some embodiments, a method comprises depositing a first material on a substrate, wherein the first material forms a first pattern on the substrate; depositing a second material on the substrate, wherein: the second material forms a second pattern on the substrate, and the first pattern at least partially overlaps the second pattern; and exposing the first material and the second material to light to form a first optical element in the first material and a second optical element in the second material, wherein the second optical element is smaller than the first optical element. The first material can have a different spatial frequency response than the second material.

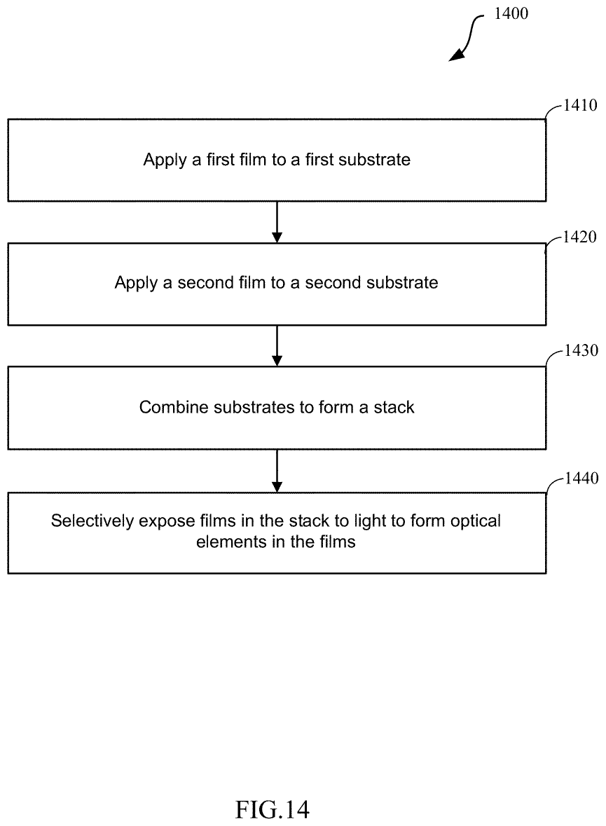

FIG. 14 is a simplified flow chart 1400 illustrating an example of a method of creating a stacked optical device according to certain embodiments. The operations described in flow chart 1400 are for illustration purposes only and are not intended to be limiting. In various implementations, modifications may be made to flow chart 1400 to add additional operations, omit some operations, combine some operations, split some operations, or reorder some operations.

At block 1410, a first film is applied to a first substrate. For example, the first film 1110 is applied to the first substrate 1112, as described in FIG. 11. The first film can cover all or part of a surface of the first substrate.

At block 1420, a second film is applied to a second substrate. For example, the second film 1120 is applied to the second substrate 1122, as described in FIG. 11. A third film (e.g., the third film 1130 in FIG. 11) can be applied to a third substrate (e.g., the third substrate 1132 in FIG. 11). In some embodiments the second film is applied to the second substrate after applying the first film to the first substrate (e.g., films deposited sequentially).

At block 1430, the first substrate and the second substrate are combined to form a stack. For example the first substrate 1112, the second substrate 1122, and optionally the third substrate 1132 (or other substrates, such as the fourth substrate 1142) are combined to form the stack 1104 as described in FIG. 11. The second substrate 1122 at least partially overlaps the first substrate 1112 (e.g., configured so that some light that is transmitted through the second substrate 1122 is also transmitted through the first substrate 1112, unless absorbed by the first film 1110).

At block 1440, films in the stack are selectively exposed to light to form optical elements in the films of the stack. For example, the stack 1104 in FIG. 11 is exposed to red light, green light, and blue light. Red light is used to form optical elements in the first film 1110, green light is used to form optical elements in the second film 1120, and blue light is used to form optical elements in the third film 1130. The first substrate 1112, the second substrate 1122, and the third substrate 1132 could be combined before or after exposing films to light to form optical elements.

In some embodiments, a method comprises applying a first film to a first substrate, wherein the first film is tuned to have a first absorption band centered at a first wavelength; applying a second film to a second substrate, wherein: the second film is tuned to have second absorption band centered at a second wavelength, and the second wavelength is different from the first wavelength; spatially overlapping the first substrate and the second substrate to form a stack; exposing the first film to light having a wavelength within the first absorption band to form a first optical element in the first film; and exposing the second film to light having a wavelength within the second absorption band to form a second optical element in the second film. A third film can be applied to a third substrate, wherein the third film is tuned to have a third absorption band centered at a third wavelength; overlapping the first substrate, the second substrate, and the third substrate to form the stack; and/or exposing the stack to light having a wavelength within the third absorption band to record a third optical element in the third film. Films can be tuned to respond to visible light (e.g., between 400 and 700 nm). Exposing the films can be performed before or after creating a stack (e.g., stack 1104).

In some embodiments, a method comprises exposing a first film on a first substrate to light having a wavelength within a first absorption band to form a first optical element in the first film, wherein the first film is tuned to have the first absorption band centered at a first wavelength (e.g., the first wavelength 1215); exposing a second film on a second substrate to light having a wavelength within a second absorption band to form a second optical element in the second film, wherein the second film is tuned to have the second absorption band centered at a second wavelength (e.g., the second wavelength 1225); exposing a third film on a third substrate to light having a wavelength within a third absorption band to form a third optical element in the third film, wherein the third film is tuned to have the third absorption band centered at a third wavelength (e.g., the third wavelength 1235); and overlapping the first substrate, the second substrate, and the third substrate to form a stack. The first optical element, the second optical element, and/or the third optical element can be volume Bragg gratings. In some embodiments, substrates 1112, 1122, 1132, and/or 1142 are not configured to be waveguides. There can be spatial variation between exposure of light having the wavelength within the first absorption band and exposure of light having the wavelength within the second absorption band (e.g., exposing light within the first absorption band can form elements in a film on the right side of the stack 1104 and/or exposing light within the second absorption band can form optical elements in a film on the left side of the stack). The first wavelength can be red light (e.g., between 635 nm and 700 nm); the second wavelength can be green light (e.g., between 520 nm and 560 nm); and/or the third wavelength can be blue light (e.g., between 450 nm and 490 nm).

The specific details of particular embodiments may be combined in any suitable manner without departing from the spirit and scope of embodiments of the invention. However, other embodiments of the invention may be directed to specific embodiments relating to each individual aspect, or specific combinations of these individual aspects.

The above description of exemplary embodiments has been presented for the purposes of illustration and description. It is not intended to be exhaustive or to limit the invention to the precise form described, and many modifications and variations are possible in light of the teaching above. For example, instead of exposing materials or films to light, electron-beam lithography could be used.

Embodiments of the invention may be used to fabricate components of an artificial reality system or may be implemented in conjunction with an artificial reality system. Artificial reality is a form of reality that has been adjusted in some manner before presentation to a user, which may include, for example, a virtual reality (VR), an augmented reality (AR), a mixed reality (MR), a hybrid reality, or some combination and/or derivatives thereof. Artificial reality content may include completely generated content or generated content combined with captured (e.g., real-world) content. The artificial reality content may include video, audio, haptic feedback, or some combination thereof, and any of which may be presented in a single channel or in multiple channels (such as stereo video that produces a three-dimensional effect to the viewer). Additionally, in some embodiments, artificial reality may also be associated with applications, products, accessories, services, or some combination thereof, that are used to, for example, create content in an artificial reality and/or are otherwise used in (e.g., perform activities in) an artificial reality. The artificial reality system that provides the artificial reality content may be implemented on various platforms, including a head-mounted display (HMD) connected to a host computer system, a standalone HMD, a mobile device or computing system, or any other hardware platform capable of providing artificial reality content to one or more viewers.

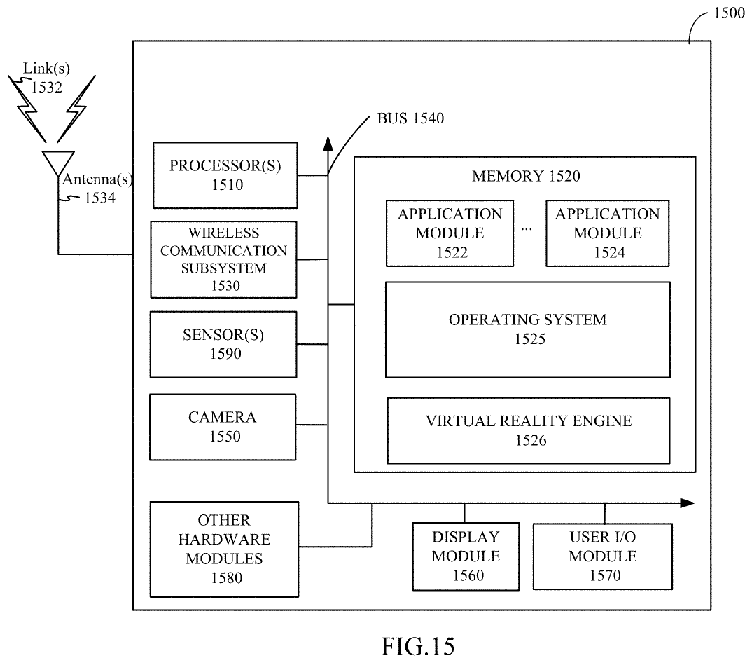

FIG. 15 is a simplified block diagram of an example of an electronic system 1500 of a near-eye display system (e.g., HMD device) for implementing some of the examples disclosed herein. Electronic system 1500 may be used as the electronic system of an HMD device or other near-eye displays described above. In this example, electronic system 1500 may include one or more processor(s) 1510 and a memory 1520. Processor(s) 1510 may be configured to execute instructions for performing operations at a number of components, and can be, for example, a general-purpose processor or microprocessor suitable for implementation within a portable electronic device. Processor(s) 1510 may be communicatively coupled with a plurality of components within electronic system 1500. To realize this communicative coupling, processor(s) 1510 may communicate with the other illustrated components across a bus 1540. Bus 1540 may be any subsystem adapted to transfer data within electronic system 1500. Bus 1540 may include a plurality of computer buses and additional circuitry to transfer data.

Memory 1520 may be coupled to processor(s) 1510. In some embodiments, memory 1520 may offer both short-term and long-term storage and may be divided into several units. Memory 1520 may be volatile, such as static random access memory (SRAM) and/or dynamic random access memory (DRAM) and/or non-volatile, such as read-only memory (ROM), flash memory, and the like. Furthermore, memory 1520 may include removable storage devices, such as secure digital (SD) cards. Memory 1520 may provide storage of computer-readable instructions, data structures, program modules, and other data for electronic system 1500. In some embodiments, memory 1520 may be distributed into different hardware modules. A set of instructions and/or code might be stored on memory 1520. The instructions might take the form of executable code that may be executable by electronic system 1500, and/or might take the form of source and/or installable code, which, upon compilation and/or installation on electronic system 1500 (e.g., using any of a variety of generally available compilers, installation programs, compression/decompression utilities, etc.), may take the form of executable code.

In some embodiments, memory 1520 may store a plurality of application modules 1522 through 1524, which may include any number of applications. Examples of applications may include gaming applications, conferencing applications, video playback applications, or other suitable applications. The applications may include a depth sensing function or eye tracking function. Application modules 1522-1524 may include particular instructions to be executed by processor(s) 1510. In some embodiments, certain applications or parts of application modules 1522-1524 may be executable by other hardware modules 1580. In certain embodiments, memory 1520 may additionally include secure memory, which may include additional security controls to prevent copying or other unauthorized access to secure information.

In some embodiments, memory 1520 may include an operating system 1525 loaded therein. Operating system 1525 may be operable to initiate the execution of the instructions provided by application modules 1522-1524 and/or manage other hardware modules 1580 as well as interfaces with a wireless communication subsystem 1530 which may include one or more wireless transceivers. Operating system 1525 may be adapted to perform other operations across the components of electronic system 1500 including threading, resource management, data storage control and other similar functionality.

Wireless communication subsystem 1530 may include, for example, an infrared communication device, a wireless communication device and/or chipset (such as a Bluetooth® device, an IEEE 802.11 device, a Wi-Fi device, a WiMax device, cellular communication facilities, etc.), and/or similar communication interfaces. Electronic system 1500 may include one or more antennas 1534 for wireless communication as part of wireless communication subsystem 1530 or as a separate component coupled to any portion of the system. Depending on desired functionality, wireless communication subsystem 1530 may include separate transceivers to communicate with base transceiver stations and other wireless devices and access points, which may include communicating with different data networks and/or network types, such as wireless wide-area networks (WWANs), wireless local area networks (WLANs), or wireless personal area networks (WPANs). A WWAN may be, for example, a WiMax (IEEE 802.16) network. A WLAN may be, for example, an IEEE 802.11x network. A WPAN may be, for example, a Bluetooth network, an IEEE 802.15x, or some other types of network. The techniques described herein may also be used for any combination of WWAN, WLAN, and/or WPAN. Wireless communications subsystem 1530 may permit data to be exchanged with a network, other computer systems, and/or any other devices described herein. Wireless communication subsystem 1530 may include a means for transmitting or receiving data, such as identifiers of HMD devices, position data, a geographic map, a heat map, photos, or videos, using antenna(s) 1534 and wireless link(s) 1532. Wireless communication subsystem 1530, processor(s) 1510, and memory 1520 may together comprise at least a part of one or more of a means for performing some functions disclosed herein.

Embodiments of electronic system 1500 may also include one or more sensors 1590. Sensor(s) 1590 may include, for example, an image sensor, an accelerometer, a pressure sensor, a temperature sensor, a proximity sensor, a magnetometer, a gyroscope, an inertial sensor (e.g., a module that combines an accelerometer and a gyroscope), an ambient light sensor, or any other similar module operable to provide sensory output and/or receive sensory input, such as a depth sensor or a position sensor. For example, in some implementations, sensor(s) 1590 may include one or more inertial measurement units (IMUs) and/or one or more position sensors. An IMU may generate calibration data indicating an estimated position of the HMD device relative to an initial position of the HMD device, based on measurement signals received from one or more of the position sensors. A position sensor may generate one or more measurement signals in response to motion of the HMD device. Examples of the position sensors may include, but are not limited to, one or more accelerometers, one or more gyroscopes, one or more magnetometers, another suitable type of sensor that detects motion, a type of sensor used for error correction of the IMU, or some combination thereof. The position sensors may be located external to the IMU, internal to the IMU, or some combination thereof. At least some sensors may use a structured light pattern for sensing.

Electronic system 1500 may include a display module 1560. Display module 1560 may be a near-eye display, and may graphically present information, such as images, videos, and various instructions, from electronic system 1500 to a user. Such information may be derived from one or more application modules 1522-1524, virtual reality engine 1526, one or more other hardware modules 1580, a combination thereof, or any other suitable means for resolving graphical content for the user (e.g., by operating system 1525). Display module 1560 may use liquid crystal display (LCD) technology, light-emitting diode (LED) technology (including, for example, OLED, ILED, mLED, AMOLED, TOLED, etc.), light emitting polymer display (LPD) technology, or some other display technology.

Electronic system 1500 may include a user input/output module 1570. User input/output module 1570 may allow a user to send action requests to electronic system 1500. An action request may be a request to perform a particular action. For example, an action request may be to start or end an application or to perform a particular action within the application. User input/output module 1570 may include one or more input devices. Example input devices may include a touchscreen, a touch pad, microphone(s), button(s), dial(s), switch(es), a keyboard, a mouse, a game controller, or any other suitable device for receiving action requests and communicating the received action requests to electronic system 1500. In some embodiments, user input/output module 1570 may provide haptic feedback to the user in accordance with instructions received from electronic system 1500. For example, the haptic feedback may be provided when an action request is received or has been performed.

Electronic system 1500 may include a camera 1550 that may be used to take photos or videos of a user, for example, for tracking the user's eye position. Camera 1550 may also be used to take photos or videos of the environment, for example, for VR, AR, or MR applications. Camera 1550 may include, for example, a complementary metal-oxide-semiconductor (CMOS) image sensor with a few millions or tens of millions of pixels. In some implementations, camera 1550 may include two or more cameras that may be used to capture 3-D images.

In some embodiments, electronic system 1500 may include a plurality of other hardware modules 1580. Each of other hardware modules 1580 may be a physical module within electronic system 1500. While each of other hardware modules 1580 may be permanently configured as a structure, some of other hardware modules 1580 may be temporarily configured to perform specific functions or temporarily activated. Examples of other hardware modules 1580 may include, for example, an audio output and/or input module (e.g., a microphone or speaker), a near field communication (NFC) module, a rechargeable battery, a battery management system, a wired/wireless battery charging system, etc. In some embodiments, one or more functions of other hardware modules 1580 may be implemented in software.

In some embodiments, memory 1520 of electronic system 1500 may also store a virtual reality engine 1526. Virtual reality engine 1526 may execute applications within electronic system 1500 and receive position information, acceleration information, velocity information, predicted future positions, or some combination thereof of the HMD device from the various sensors. In some embodiments, the information received by virtual reality engine 1526 may be used for producing a signal (e.g., display instructions) to display module 1560. For example, if the received information indicates that the user has looked to the left, virtual reality engine 1526 may generate content for the HMD device that mirrors the user's movement in a virtual environment. Additionally, virtual reality engine 1526 may perform an action within an application in response to an action request received from user input/output module 1570 and provide feedback to the user. The provided feedback may be visual, audible, or haptic feedback. In some implementations, processor(s) 1510 may include one or more GPUs that may execute virtual reality engine 1526.

In various implementations, the above-described hardware and modules may be implemented on a single device or on multiple devices that can communicate with one another using wired or wireless connections. For example, in some implementations, some components or modules, such as GPUs, virtual reality engine 1526, and applications (e.g., tracking application), may be implemented on a console separate from the head-mounted display device. In some implementations, one console may be connected to or support more than one HMD.

In alternative configurations, different and/or additional components may be included in electronic system 1500. Similarly, functionality of one or more of the components can be distributed among the components in a manner different from the manner described above. For example, in some embodiments, electronic system 1500 may be modified to include other system environments, such as an AR system environment and/or an MR environment.

The methods, systems, and devices discussed above are examples. Various embodiments may omit, substitute, or add various procedures or components as appropriate. For instance, in alternative configurations, the methods described may be performed in an order different from that described, and/or various stages may be added, omitted, and/or combined. Also, features described with respect to certain embodiments may be combined in various other embodiments. Different aspects and elements of the embodiments may be combined in a similar manner. Also, technology evolves and, thus, many of the elements are examples that do not limit the scope of the disclosure to those specific examples.

Specific details are given in the description to provide a thorough understanding of the embodiments. However, embodiments may be practiced without these specific details. For example, well-known circuits, processes, systems, structures, and techniques have been shown without unnecessary detail in order to avoid obscuring the embodiments. This description provides example embodiments only, and is not intended to limit the scope, applicability, or configuration of the invention. Rather, the preceding description of the embodiments will provide those skilled in the art with an enabling description for implementing various embodiments. Various changes may be made in the function and arrangement of elements without departing from the spirit and scope of the present disclosure.

Also, some embodiments were described as processes depicted as flow diagrams or block diagrams. Although each may describe the operations as a sequential process, many of the operations may be performed in parallel or concurrently. In addition, the order of the operations may be rearranged. A process may have additional steps not included in the figure. Furthermore, embodiments of the methods may be implemented by hardware, software, firmware, middleware, microcode, hardware description languages, or any combination thereof. When implemented in software, firmware, middleware, or microcode, the program code or code segments to perform the associated tasks may be stored in a computer-readable medium such as a storage medium. Processors may perform the associated tasks.

It will be apparent to those skilled in the art that substantial variations may be made in accordance with specific requirements. For example, customized or special-purpose hardware might also be used, and/or particular elements might be implemented in hardware, software (including portable software, such as applets, etc.), or both. Further, connection to other computing devices such as network input/output devices may be employed.

With reference to the appended figures, components that can include memory can include non-transitory machine-readable media. The term “machine-readable medium” and “computer-readable medium” may refer to any storage medium that participates in providing data that causes a machine to operate in a specific fashion. In embodiments provided hereinabove, various machine-readable media might be involved in providing instructions/code to processing units and/or other device(s) for execution. Additionally or alternatively, the machine-readable media might be used to store and/or carry such instructions/code. In many implementations, a computer-readable medium is a physical and/or tangible storage medium. Such a medium may take many forms, including, but not limited to, non-volatile media, volatile media, and transmission media. Common forms of computer-readable media include, for example, magnetic and/or optical media such as compact disk (CD) or digital versatile disk (DVD), punch cards, paper tape, any other physical medium with patterns of holes, a RAM, a programmable read-only memory (PROM), an erasable programmable read-only memory (EPROM), a FLASH-EPROM, any other memory chip or cartridge, a carrier wave as described hereinafter, or any other medium from which a computer can read instructions and/or code. A computer program product may include code and/or machine-executable instructions that may represent a procedure, a function, a subprogram, a program, a routine, an application (App), a subroutine, a module, a software package, a class, or any combination of instructions, data structures, or program statements.

Those of skill in the art will appreciate that information and signals used to communicate the messages described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Terms, “and” and “or” as used herein, may include a variety of meanings that are also expected to depend at least in part upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, AB, AC, BC, AA, ABC, AAB, AABBCCC, etc.

Further, while certain embodiments have been described using a particular combination of hardware and software, it should be recognized that other combinations of hardware and software are also possible. Certain embodiments may be implemented only in hardware, or only in software, or using combinations thereof. In one example, software may be implemented with a computer program product containing computer program code or instructions executable by one or more processors for performing any or all of the steps, operations, or processes described in this disclosure, where the computer program may be stored on a non-transitory computer readable medium. The various processes described herein can be implemented on the same processor or different processors in any combination.

Where devices, systems, components or modules are described as being configured to perform certain operations or functions, such configuration can be accomplished, for example, by designing electronic circuits to perform the operation, by programming programmable electronic circuits (such as microprocessors) to perform the operation such as by executing computer instructions or code, or processors or cores programmed to execute code or instructions stored on a non-transitory memory medium, or any combination thereof. Processes can communicate using a variety of techniques, including, but not limited to, conventional techniques for inter-process communications, and different pairs of processes may use different techniques, or the same pair of processes may use different techniques at different times.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific embodiments have been described, these are not intended to be limiting. Various modifications and equivalents are within the scope of the following claims.

What is claimed is:

1. A device comprising:
a first holographic recording material disposed on a substrate, wherein the first holographic recording material comprises a first optical element;
a second holographic recording material disposed on the substrate, wherein:
the second holographic recording material comprises a second optical element; and
the second optical element is smaller in size than the first optical element based on a property of the second holographic recording material compared to a property of the first holographic recording material.

2. The device of claim 1, wherein a refractive index of the first holographic recording material is substantially the same as a refractive index of the second holographic recording material.

3. The device of claim 1, wherein the first optical element and the second optical element are volume Bragg gratings.

4. The device of claim 3, wherein the second optical element is smaller in size than the first optical element by having a smaller pitch than the first optical element.

5. The device of claim 1, wherein the first holographic recording material is disposed on the substrate in a first pattern that at least partially overlaps a second pattern of the second holographic recording material disposed on the substrate.

6. A method comprising:
depositing a first material on a substrate, wherein the first material forms a first pattern on the substrate;
depositing a second material on the substrate, wherein:
the second material forms a second pattern on the substrate; and
the first pattern at least partially overlaps the second pattern; and
exposing the first material and the second material to light to form a first optical element in the first material and a second optical element in the second material, wherein the second optical element is smaller than the first optical element.

7. The method of claim 6, wherein a refractive index of the first material is substantially the same as a refractive index of the second material.

8. The method of claim 6, wherein:
the first material has a first diffusion coefficient;
the second material has a second diffusion coefficient; and
the first diffusion coefficient is greater than the second diffusion coefficient.

9. The method of claim 6, wherein the first optical element and the second optical element are holographic Bragg gratings.

10. The method of claim 6, wherein the first material has a different spatial frequency response than the second material.

11. A method comprising:
applying a first material to a substrate, wherein:
the first material comprises a first matrix, a first monomer, and a first photoinitiator;
the first monomer is a writing monomer configured to polymerize based on a reaction with the first photoinitiator; and
the first material is characterized by a first diffusion coefficient of the first monomer in the first matrix;
applying a second material to the substrate, wherein:
the second material comprises a second matrix, a second monomer, and a second photoinitiator;
the second monomer is a writing monomer configured to polymerize based on a reaction with the second photoinitiator;
the second material is characterized by a second diffusion coefficient of the second monomer in the second matrix; and
the second diffusion coefficient is less than the first diffusion coefficient; and
exposing the first material and the second material to light to form optical elements in the first material and in the second material.

12. The method of claim 11, wherein:
the first matrix has a first refractive index;
the second matrix has a second refractive index; and
the first refractive index is substantially the same as the second refractive index.

13. The method of claim 12, wherein there is less than a 0.001 difference between the first refractive index and the second refractive index.

14. The method of claim 11, wherein the optical elements comprise a first grating in the first material, the first grating having a first pitch, and a second grating in the second material, the second grating having a second pitch.

15. The method of claim 14, wherein the first pitch is larger than the second pitch based on the first diffusion coefficient being greater than the second diffusion coefficient.

16. The method of claim 11, wherein the first matrix and the second matrix are resins while applied to the substrate.

17. The method of claim 11, further comprising depositing the first material and the second material with an ink-jet dispenser.

18. The method of claim 11, further comprising depositing the first material and the second material on the substrate to form a concentration gradient of the first material and the second material.

19. The method of claim 11, wherein
the first material and the second material are holographic recording materials; and
the optical elements form a volume Bragg grating.

20. The method of claim 11, wherein:
the optical elements comprise a first optical element in the first material and a second optical element in the second material; and
the second optical element is smaller in size than the first optical element.
